(19) United States
(12) Patent Application Publication
(10) Pub. No.: US 2013/0212017 A1
(43) Pub. Date: Aug. 15, 2013

(54) TRANSACTION SYSTEM AND METHOD OF CONDUCTING A TRANSACTION

(71) Applicant: Naresh BANGIA, Toronto (CA)

(72) Inventor: Naresh BANGIA, Toronto (CA)

(73) Assignee: N.B. DEVELOPMENT SERVICES INC., Mississauga (CA)

(21) Appl. No.: 13/372,876

(22) Filed: Feb. 14, 2012

(51) Int. Cl. G06Q 20/40; G06Q 20/32

(52) U.S. Cl. 705/44

(57) ABSTRACT

The invention pertains to a transaction system and method of conducting a transaction. Particularly, the invention pertains to a transaction system and method of conducting a transaction wherein the transaction is initiated by the consumer using a mobile device with a unique identifier. The consumer initiates the transaction by entering a vendor provided transaction initiation code into the mobile device. The transaction identifier code and unique identifier of the mobile device is transmitted to a server. Using the unique identifier the server can retrieve pre-existing transaction options specific to the unique identifier of the mobile device. The transaction options can either be transmitted to the mobile device to allow the consumer to input any preferences relating to the transaction options or to a vendor sales system of a vendor for further processing.

### FIELD OF THE INVENTION

The invention pertains to a transaction system and method of conducting a transaction. Particularly, the invention pertains to a financial transaction system and method of conducting a financial transaction wherein the financial transaction is initiated by the consumer using an application on a mobile device.

### BACKGROUND OF THE INVENTION

Cashless transaction systems are well known. Credit or debit cards can be used at most retail locations. A vendor typically has a vendor sales system, often comprising or incorporating one or more point of sale (“POS”) terminals, which processes financial transactions through communications with third party financial institutions 130, such as credit card companies and banks with whom a consumer has previously made credit or cash deposit arrangements. To make a purchase, the consumer provides the vendor with a physical payment facility, such as a credit or debit card, and uses the vendor sales system to both initiate and process the cash-less payment. In many cases, the consumer must physically travel to the fixed location of the vendor sales system to effect payment. Alternatively, a vendor employee retrieves the card from the consumer, takes it to the fixed location, attends to the processing and returns to the consumer to authorize the payment. Sometimes, this back and forth travel can be inconvenient, for example in moving from an outside vending station (e.g. a gasoline pump) to an interior kiosk through rain, snow or slush and there possibly having to wait in a queue.

Some of these types of transaction systems are also available in a mobile form. The mobile systems comprise a mobile terminal which is capable of transmitting and receiving information wirelessly to or from the third party financial institutions. Such systems are typically found at dine-in restaurants or other locations in which it is inconvenient for a consumer to relocate to a fixed financial transaction system that processes the payment. With this system, a staff member of the vendor brings the consumer a bill. When the consumer indicates they would like to pay with a payment facility such as a credit card, the staff member retrieves the mobile terminal, inputs relevant payment data, obtains the payment facility card, inputs the payment facility information into the terminal (for example, by swiping a magnetic strip on the card or inserting a chip to connect to the system) and processes the transaction. Often the staff members will have to leave the consumer to retrieve the mobile terminal which is time consuming and inconvenient.

Such prior art systems do not assist a consumer in ordering goods or services to be purchased, in eliminating the need to carry one or more physical payment facilities, or in avoiding the need for the consumer or the vendor's staff to travel between the point of purchase and the fixed location of the vendor sales system.

With the increasing capability and popularity of personal mobile devices, there is greater demand to develop technology to enable the user of a mobile device to perform everyday tasks, with their mobile device. Currently, the internet capability built in to mobile devices allows the user to interact with websites. This enables them to make online payments using a credit card or another payment facility. This payment facility information is potentially stored in the mobile device and is at risk should the device be lost or stolen or its transmission be intercepted.

Website based secure payment sites exist to facilitate online payments in a manner that does not require entry at the time of purchase of payment facility information. To use these sites, a user must access a website and set up a personal account. As part of the set up process, the user enters a personal identifier and their payment facility information. The payment facility information can then be recalled at a later date, i.e. when a purchase is being made, in response to entry by the user of their personal identifier. Personal identifiers may be in the form of an email or user name. The additional security of a password unique to the personal identifier is typically provided. This type of financial transaction system is restricted or incapable of completing sales that do not occur online.

### SUMMARY OF THE INVENTION

The invention pertains to a method of initiating financial transactions using mobile devices having unique identification codes, a vendor sales system and a server having a database for the mobile devices containing the unique identification code for each mobile device and an associated transaction option. The method comprises providing a transaction initiation code of a specific financial transaction, entering the transaction initiation code into a mobile device, transmitting the transaction initiation code and the unique identification code of the mobile device to the server. The server receives the transaction initiation code and the unique identification code of the mobile device, uses the database and the received unique identification code to determine the associated transaction option and communicates the transaction initiation code and the determined associated transaction option to the vendor sales system for further processing of the financial transaction.

In a further embodiment, the associated transaction option includes at least one associated payment facility to settle the transaction and at least one predetermined associated order information used communicate a desired order to the vendor sales system.

In yet a further embodiment, the step of entering the transaction initiation code includes initiating a transaction application installed on the mobile device and entering the transaction initiation code in the application as required. The associated transaction option is used to complete the financial transaction.

In yet a further embodiment, the associated transaction option stored in the database is the associated payment facility used to settle the financial transaction.

In yet a further embodiment, the step of entering the transaction initiation code includes initiating a financial transaction application installed on the mobile device and entering the transaction initiation code in the application as required.

In yet a further embodiment the step of entering the transaction initiation code includes initiating a payment application specific to the vendor installed on the mobile device and entering the transaction initiation code in the payment application as required.

In yet a further embodiment, the further processing includes the vendor sales system receiving an acknowledgement of confirmation of successful payment and the vendor sales system transmitting an acknowledgement of payment to the server. The server then receives the acknowledgement of payment and transmits the acknowledgement of payment to the mobile device. The mobile device displays the acknowledgement of payment.

In yet a further embodiment, the transaction identification code further contains the unique identifier of a second mobile device and the further processing includes the vendor sales system receiving an acknowledgement of confirmation of successful payment as part of the further processing. Upon receiving the acknowledgement, the vendor sales system transmits acknowledgement of payment to the server. The server receives the acknowledgement of payment and transmits the acknowledgement of payment to the second mobile device. The second mobile device displays the acknowledgement of payment.

In yet a further embodiment, the server cooperates with the vendor sales system to provide an electronic receipt to an address associated with the mobile device.

In yet a further embodiment, the server maintains a database of electronic receipts associated with the mobile devices that are accessible to the mobile device.

In yet a further embodiment, the step of communicating the transaction initiation code and the determined associated payment facility to the vendor sales system for further processing of the financial transaction is a multi-step process. This process comprises the steps of the server initially transmitting the transaction identification code to the vendor sales system, recalling transaction details stored in the vendor sales system using the transaction identification code and transmitting the transaction details to the server. The server then transmits the transaction details to the mobile device, displays the transaction details on the mobile device, receives an authorization input into the mobile device and transmits authorization to the server. The server transmits the authorization and payment facility to the vendor sales system for further processing of the financial transaction.

In yet a further embodiment, the database includes one or more payment facilities with respect to each mobile device and the server and the mobile device cooperate to allow selection of a specific payment facility using the mobile device.

Another embodiment of the invention pertains to a method for initiating a financial transaction between a mobile device with a unique identification code and a vendor sales system of a vendor using a server as an intermediary that maintains a database of one or more pre-determined specific payment facilities associated with the unique identification code of the mobile device. The method comprises entering a transaction initiation code, associated by the vendor with a transaction about to be initiated, into the mobile device. The mobile device transmits the transaction initiation code and the unique identification code to the server, retrieves from the database the pre-determined specific payment facilities associated with the unique identification code and selects one thereof to be a selected payment facility to be associated with the transaction. The transaction initiation code is associated with the selected payment facility and the associated transaction initiation code and selected payment facility is communicated from the server to the vendor sales system for further processing.

Another embodiment of the invention pertains to a vendor sales system comprising a conventional payment terminal for accepting payment cards and extracting payment information therefrom when presented by a consumer, a computer system cooperating with the conventional payment terminal to receive the payment information and to combine the payment information with specific transaction information. The computer system includes a communication capability to provide the payment information and transaction information to the appropriate authority for payment card authorization and subsequent processing to settle the transaction using the payment card. The vendor sales system includes a non conventional mobile device payment capability that cooperates with a server. The non conventional mobile device payment capability includes a communication channel for receiving an initiating input communication from the server containing a transaction initiation code of a specific transaction stored in the computer system and payment information. The non conventional mobile device payment capability upon receiving an initiating input communication uses the transaction initiation code and the payment information to exchange a series of communications with the server device to complete settlement of the specific transaction using the payment information.

In a further embodiment, the vendor sales system is in combination with the server. The server initiates the input communication with the non conventional mobile device payment capability based on receiving a mobile device initiation communication from a registered mobile device known to the server where the mobile device initiation communication includes the transaction identification code and an information identifying the mobile device to the server. The server retrieves from a database associated with the server, previously recorded payment information of the mobile device using the information identifying the mobile device. The server uses the payment information and the transaction identification information to produce the initiating input communication.

Another embodiment of the invention pertains to a system for initiating a transaction based on a consumer initiated communication comprising a vendor sales system transaction arrangement, a server and a host of mobile devices and a computer system. The vendor sales system transaction arrangement comprises a payment terminal for accepting payment cards and extracting payment information therefrom when presented by a consumer. A computer system cooperates with the conventional payment terminal to receive the payment information and to combine the payment information with specific transaction information. The computer system includes a communication capability to provide the payment information and transaction information to an appropriate authority for payment card authorization and subsequent processing to settle the transaction using the payment card. The vendor sales system transaction arrangement includes a mobile device payment capability that communicates with the server. The server includes an associated database containing a unique identification code for each mobile device and an associated transaction option for the mobile device. Each mobile device includes a transaction initiation function requiring the entry of a consumer provided transaction initiation code of a specific financial transaction known to the vendor sales system transaction arrangement and after entry of the transaction initiation code communicating with the server and providing thereto the transaction initiation code and the unique identification code. The server uses the communicated the unique identification code of the mobile device to determine from the database the associated transaction option. The server completes a communication with the vendor sales system transaction arrangement and providing thereto the transaction initiation code and the determined associated transaction option for further processing by the vendor sales system arrangement in accordance the transaction option.

In a further embodiment, the transaction option for the mobile devices includes payment facility associated with the mobile device to settle the financial transaction when provided to the vendor sales system transaction arrangement.

### BRIEF DESCRIPTION OF THE DRAWINGS

Preferred embodiments of the invention are shown in the drawings, wherein:

FIG. 1 is a schematic of the transaction system;

FIG. 2 is a flowchart of a methodology for a mobile device to conduct a transaction using a server;

FIG. 3 is a flowchart providing additional detail of exemplary steps for determining a transaction option of a particular financial transaction;

FIG. 4 is a flowchart providing details of the steps carried out in an optional preliminary transaction identification code check and action process;

FIG. 5 is a schematic of the transaction system for use in conducting a financial transaction;

FIGS. 6A and 6B are a flowchart providing detail of further exemplary steps carried out by the transaction system after receiving transaction option information from a server;

FIG. 7 is a flowchart providing details of an exemplary termination process;

FIG. 8 is a screenshot depicting an example of how the mobile device screen may look upon initiation of the application;

FIG. 9 is a screenshot depicting an example of how the mobile device screen may look when prompting a consumer for a choice of payment facility options;

FIGS. 10A and 10B are a flowchart providing details of the steps carried out in an optional verification and tip process;

FIG. 11 is a schematic of the transaction system at a dine-in restaurant;

FIGS. 12A and 128 are a flowchart of a method for conducting a transaction using a mobile device when the optional preliminary transaction identification code check and action and the optional verification and tip process take place before determining the transaction options;

FIGS. 13A and 13B are a flowchart providing details of exemplary additional processing steps used in the method of FIG. 5A;

FIG. 14 is a schematic of the transaction system at a drive-through restaurant;

FIG. 15 is a flowchart of a method of conducting a transaction where the transaction option pertains to order information;

FIG. 16 is a flowchart of a method of conducting a transaction where a plurality of transaction options needs to be determined;

FIG. 17 is a flowchart of a method of determining a plurality of transaction options;

FIG. 18 is a schematic of the transaction system at a full-service gas station;

FIG. 19 is a schematic of the transaction system at a self-service gas station;

FIG. 20 is a schematic of the transaction system at an entertainment venue; and

FIG. 21 is a flowchart of a method of conducting a transaction that includes the delivery of a product to a consumer.

### DETAILED DESCRIPTION OF THE PREFERRED EMBODIMENTS

The invention pertains to an electronic transaction system and method where a consumer uses an application on a mobile device to conduct a transaction with a vendor. The system and method provide predetermined transaction option information that is used to conduct the transaction. One embodiment of the invention pertains to an electronic financial transaction settlement method and system that includes a consumer using an application on a mobile device to settle a financial transaction with a computer system of a vendor in a secure manner or to provide predetermined transaction option information used to conduct the financial transaction. Mobile devices include but are not limited to mobile phones, smartphones, tablets having a communication capability and like devices.

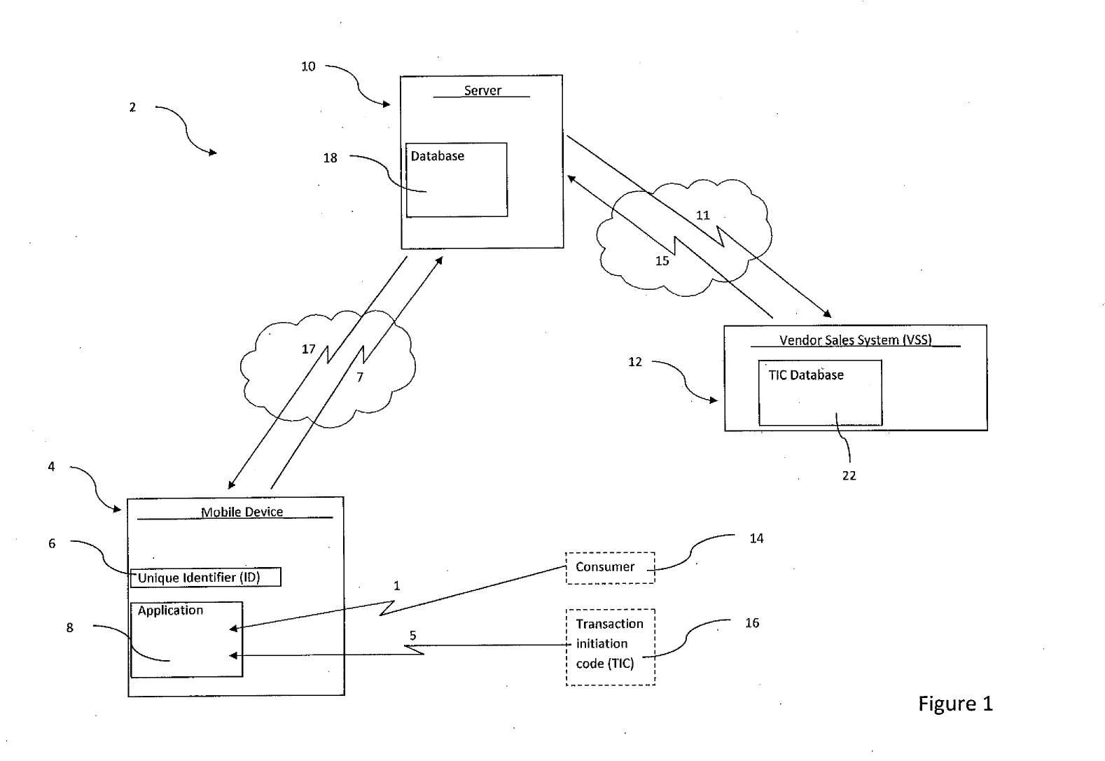

Referring to FIG. 1, an automated transaction system 2 according to the invention is depicted. Transaction system 2 includes mobile devices 4 (only one shown), each being associated with a unique identifier 6 and containing an application 8 for communicating with a server 10. Application 8 and server 10 are both associated with the particular vendor with whom the consumer desires to conduct a transaction.

Unique identifier (ID) 6 may be a serial number, a telephone number, an account number, an email address, or any other user identification code or indicia which will be recognized as unique by server 10. For added security, the unique identifier 6 may include a password component. Unique identifier 6 could be supplied by the consumer or could be previously generated and supplied by server 10 during a registration process, for example as a token or label to be used by the consumer. Unique identifier 6 may be pre-programmed into mobile device 4 but for security reasons it may be advantageous for all or a portion of identifier 6 (such as a personal identification number or PIN portion) to be input manually for each transaction or pre-determined transactions.

Application 8 may be a dedicated application created for a particular vendor or may be a general purpose Internet browser capable of linking to a particular vendor's website.

Server 10 may be dedicated to a particular vendor location. Alternatively, server 10 may be centrally located and dedicated to manage the transactions (as described in detail below) of a single vendor having multiple sales outlets. Server 10 may also be centrally located and configured to manage the transactions of multiple vendors with multiple sales outlets.

Server 10 includes or is connected to a database 18 of transaction options pre-recorded by the consumer. All transaction options recorded by the consumer are associated in database 18 with the unique identifier 6 of the consumer's mobile device 4. Database 18 may also store other information relating to the consumer such as personal information (name, address, etc.) and transaction history information.

There may be different categories of transaction options to be recorded by the consumer in database 18 depending on the types of transactions anticipated with a particular vendor. For example, one significant category of transaction options is payment facility options to enable payment to a particular vendor. In recording payment facility options, the consumer specifies the details of the various payment facilities that that consumer might wish to make use of in conducting financial transactions via transaction system 2. For instance, in one embodiment, the consumer records the details of one or more credit cards, debit cards, gift cards or other form of electronic payment for possible use in transaction system 2. In another embodiment, the category of transaction options is ordering information options for use in a food service environment. In recording ordering information options, the consumer specifies the details of the various preferred orders that the consumer might wish to make use of in conducting financial transactions via transaction system 2. For instance, the consumer may record the details of one or more favorite food and beverage orders.

The categories of transaction options also includes, but are not limited to, membership card information for use in a club or gym environment, ticket information for use at an entertainment venue, loyalty card or benefit program information, consumer preferences or any other categories of information that may be useful in simplifying a transaction using transaction system 2.

In cases where the details of certain transaction options may be deemed too sensitive to communicate between mobile device 4 and server 10 or store in mobile device 4, entries in database 18 for such transaction options may additionally include consumer-defined or server-generated placeholder labels which will be meaningful to the consumer but meaningless to any person who should happen to intercept a communication.

As will be appreciated, database 18 typically contains confidential consumer information, such as account information, personal information, credit card and debit card information, etc. When used to store confidential information, database 18 and any device on which database 18 is stored are made as secure as necessary. Database 18 may be stored on any suitable device including but not limited to an electronic vault, an internal or external drive or a cloud-based storage system. Server 10 is capable of communicating with one or more vendor sales systems (VSS) 12.

In one embodiment, vendor sales system 12 is a financial transaction system with full capability of processing a financial transaction through communications with third party financial institutions. In some embodiments, vendor sales system 12 is a point of sale system. In such cases, if full integration of the invention is preferred, such a vendor financial transaction system or point of sale system includes or is connected to a suitable interface to allow two-way communication between server 10 and such vendor financial transaction system or point of sale system.

In other embodiments, vendor sales system 12 operates in parallel with, or independently of, a vendor financial transaction system or point of sale system. For example, in one embodiment, vendor sales system 12 is a terminal to receive and display or store information about the transactions from server 10. In such an embodiment, vendor sales system 12 is used primarily to simplify or improve communications between a consumer and a staff member by displaying or storing information transmitted to vendor sales system 12 from mobile device 4 via server 10. Such an arrangement allows a staff member to input the data into the vendor's financial transaction system or point of sale system in the normal manner and the financial transaction system or point of sale system is used thereafter to carry out otherwise normal steps.

Communications between the mobile devices 4 and server 10 and between server 10 and vendor sales system 12, shown in FIG. 1 as 7, 11, 15 and 17, are conveniently effected over the internet. However, any known method of communication or transmission can be integrated into the system and method. In one embodiment, server 10 is located at the vendor site and is integrated with the vendor sales system 12. In an alternative embodiment, server 10 is located off-site and the communications are completed using the Internet or other suitable communication method or network.

Transactions are initiated using a transaction initiation code (TIC) 16 supplied by the vendor. The consumer inputs the TIC (shown as step 5) into application 8 installed on mobile device 4. In general, a transaction initiation code 16 is used to provide information to server 10 and to correlate information about the transaction with vendor sales system 12. The specific purpose of a transaction identifier code 16 can vary depending on the particular embodiment of the invention. Typically, it comprises a code that vendor sales system 12 can use to associate with, identify and/or recall particular information about a specific transaction; however, it may also comprise a code for identifying a particular retail location on a vendor's premises (or within the sales system of a chain of vendors) to be used by vendor sales system 12 to trigger certain vendor actions or to initiate communications to mobile device 4. In some embodiments, TIC 16 can be used to identify a consumer's location or simply to confirm the physical presence of the consumer in a queue.

In many embodiments, it is preferred that transaction initiation code 16 be dynamic, meaning that the code changes from transaction to transaction. However, in some embodiments (for example, where the transaction occurs at a particular service location, such as a particular gas pump at a gas station), transaction initiation code 16 could be static, meaning that the code does not change from transaction to transaction.

In some embodiments, it is possible to use global positioning system (GPS) coordinates from an internal GPS system in a mobile device 4 as all or part of transaction initiation code 16.

Transaction initiation code 16 can be presented by the vendor in any suitable manner including but not limited to by being displayed on a screen or printed on a ticket, bill or other document or transmitted via near field communication (NFC) or radio frequency identification (RFID) technologies. In the case of a static TIC 16, TIC 16 could be displayed on a permanent sign at a suitable location.

Transaction initiation code 16 is provided by the vendor in any suitable form including but not limited to as an alpha-numeric code, a conventional barcode or a quick response (QR) or other 2D barcode.

Transaction initiation code 16 is input into mobile device 4 in any suitable manner. For example, in the case of an alpha-numeric code, TIC 16 can be manually input into mobile device 4 using the keypad, dictation software, voice command software or other input system incorporated within mobile device 4. As another example, in the case of a barcode or quick response code, the consumer can photograph the code with a camera integrated within their mobile device 4 and use separate software to extract the pertinent encoded information. Should mobile device 4 be equipped with a barcode scanner, the consumer could scan the barcode as a method of inputting a transaction initiation code 16 into the mobile device 4.

In other examples, a TIC 16 is input using NFC or RFID technologies for suitably equipped mobile devices 4. In such cases, the vendor provides a transmitter capable of transmitting a signal carrying the TIC 16. When the mobile device 4 is brought into close proximity to the transmitter, the mobile device 4 receives the transmission containing the TIC 16.

As can be appreciated, any other known display, transmission or input methods could be implemented to enter TIC 16 into mobile device 4.

In contrast to conventional financial transaction systems in which transactions are initiated and conducted by or at a vendor's financial transaction system or POS system, in the manner described in detail below, use of a transaction initiation code 16 allows the consumer to use a mobile device 4 remotely to initiate and conduct a transaction through vendor sales system 12 via server 10. In essence, server 10 acts as an intelligent intermediary between mobile device 4 and vendor sales system 12.

Before undertaking any financial transactions with a particular vendor, an account set-up process in any suitable secure environment is completed by the consumer in respect of their anticipated dealings with that vendor. In such process, the consumer (or server 10 in the case of a server-generated identification) enters into database 18 the unique identifier 6 of their mobile device 4 and the consumer enters such transaction options as are selected by the consumer to be pertinent for their anticipated dealings with that vendor. In a preferred embodiment, database 18 would be accessible through a secure website. The website optionally allows for the creation of an account for the consumer, enabling them to recall and edit their database information at a later date. In one embodiment of the invention, the transaction options comprise a set of the consumer's preferred payment facilities (e.g. several credit cards) and the pertinent information about each such facility is input into database 18. In another embodiment, the transaction options comprise a set of the consumer's preferred menu or order options.

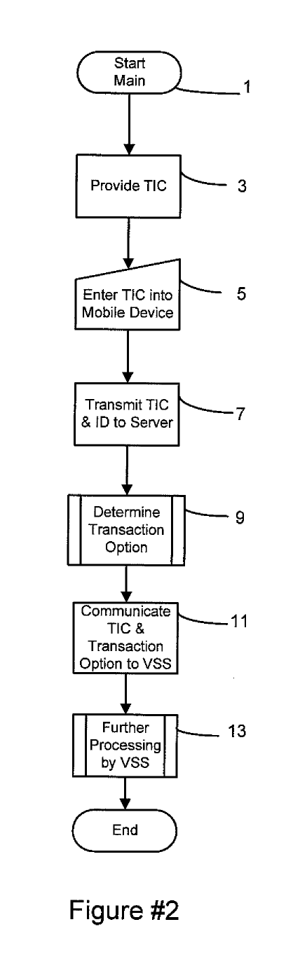

The method of conducting a transaction in accordance with the invention is shown in FIG. 2. A consumer starts at step 1 by initiating an application 8 on their mobile device 4 that will link to server 10 associated with the particular vendor of interest to the consumer. A TIC 16 is provided by the vendor at step 3. The consumer enters TIC 16 into application 8 using the mobile device 4 at step 5. At step 7, mobile device 4 transmits TIC 16 and the unique identifier 6 of mobile device 4 to server 10. At step 9, a transaction option is determined by server 10 using the unique identifier 6 to retrieve pre-recorded transaction option information about the available transaction options from server database 18 and by selection of a desired transaction option therefrom.

Server 10 transmits TIC 16 and the detailed information relating to the selected transaction option to vendor sales system 12 at step 11. In step 13, vendor sales system 12 uses TIC 16 and the transaction option information to further process the transaction to completion.

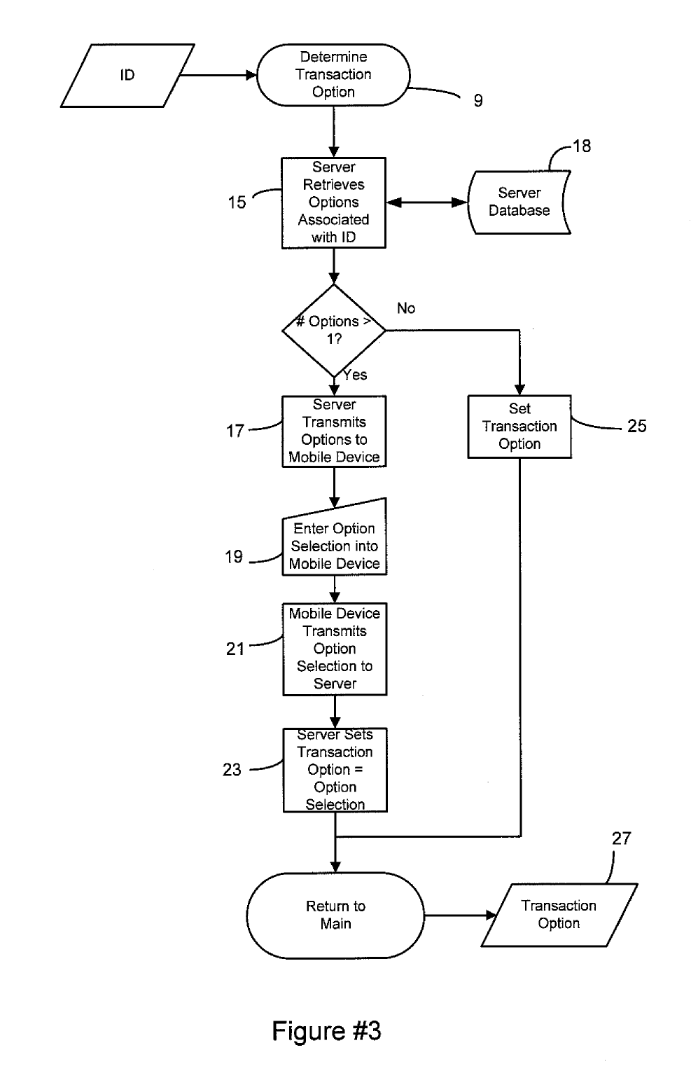

Referring to FIG. 3, additional detail is provided as to an exemplary manner of implementing step 9. Upon receiving the unique identifier 6 of mobile device 4, server 10 retrieves the associated transaction option choices from database 18 at step 15. It is possible that the transaction options include one or more choices for the transaction option. If there is only one choice, server 10 selects it as the output 27 at step 25 and the process continues at step 11 of FIG. 2. If multiple choices for the transaction option exist, steps 17, 19 and 21 are used to allow the consumer to indicate their preferred choice. In this process, the transaction option choices are transmitted to mobile device 4 at step 17. In some embodiments, it is preferred to avoid transmitting detailed information that may be associated with the transaction option choice to mobile device 4. One such example occurs when the transaction option is a choice of credit cards or other payment facilities. In this example, security is increased if the detailed credit card information is not transmitted to mobile device 4. Instead, transaction option labels (either pre-recorded in database 18 by the consumer or automatically generated by server 10) are associated with each choice to be transmitted in place of the detailed information associated with each choice.

At step 19, the consumer is presented with the transaction options and inputs their selection. As part of this step, not separately shown, a verification of the consumer's selection could be provided—for example, by displaying the selection and requesting confirmation or a change of selection. This allows the consumer to rectify any mistakes made during the input of their choice. Once the consumer has input and possibly verified their choice, the choice is transmitted to the server 10 at step 21.

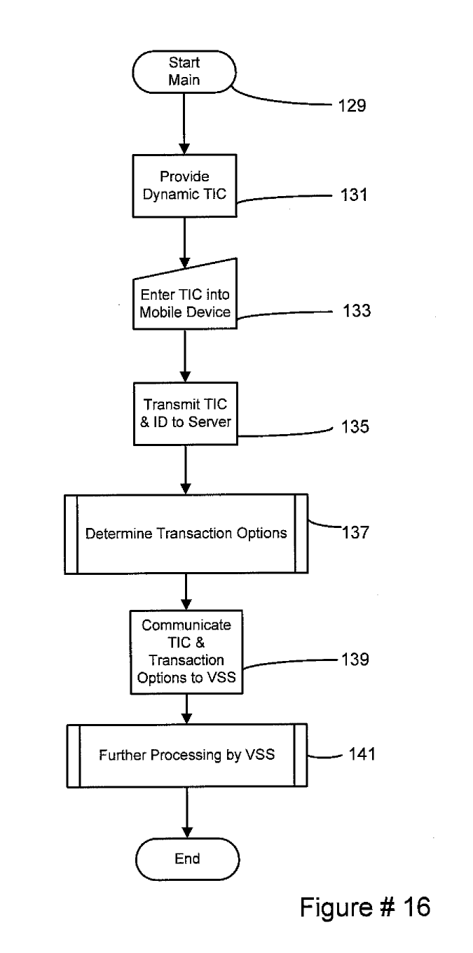

Additionally, it is possible that more than one transaction option category may need to be processed, for example in an embodiment where an order is placed and a payment is made. In these situations, the process of FIG. 3, described above, is iterated more than once to determine a transaction option for each transaction option category. An exemplary such iterative process is shown in FIG. 17 which is described in greater detail below.

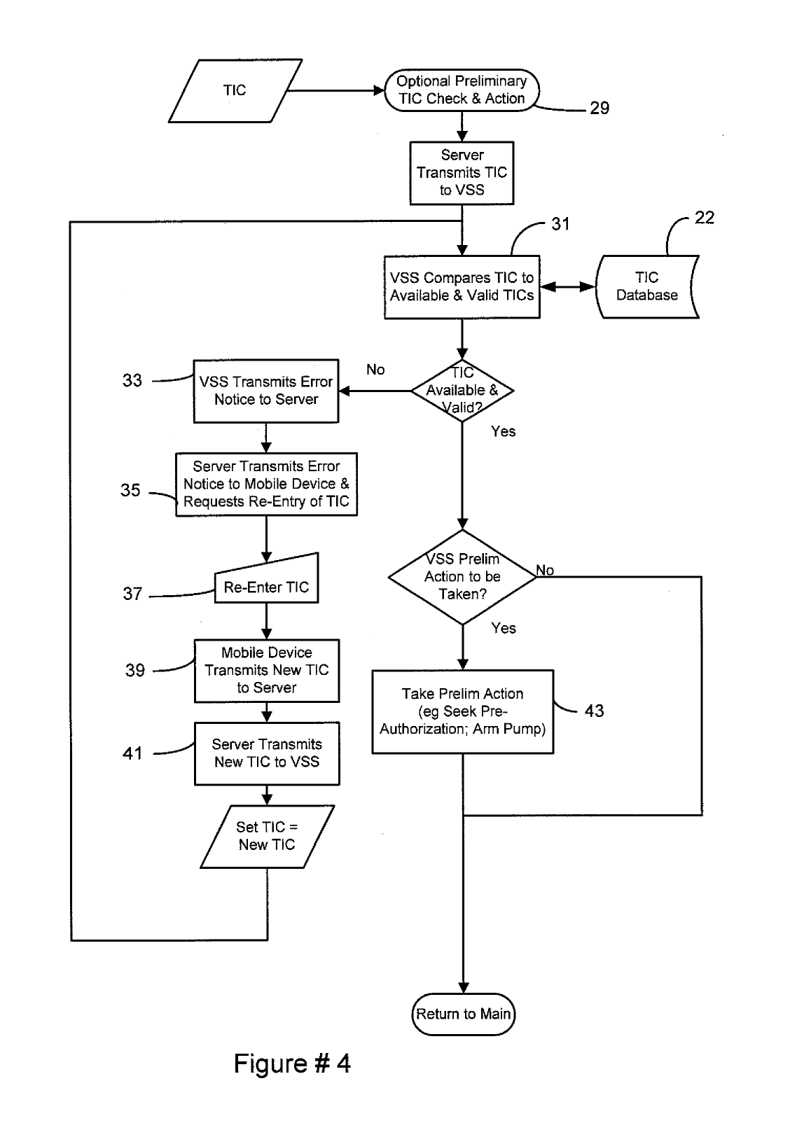

In some embodiments, it is necessary or desirable to provide a check to confirm that TIC 16 as entered by the consumer in mobile device 4 is valid and to initiate any required preliminary actions. Accordingly, in some embodiments, an optional preliminary TIC 16 check and action process 29, shown in FIG. 4, is integrated into the method of the invention. Typically, this step is integrated into the method after transmitting TIC 16 and unique identifier 6 of mobile device 4 to the server 10 (step 7 of FIG. 2). To assist in the step, a TIC database 22 is provided and is used by the vendor sales system 12 to track in real time information about all active or potentially active transactions. Such information will include all TICs which have been assigned or generated by the vendor and are in use or are available to be used. In some embodiments, TIC database 22 is used to accumulate all pertinent information about a transaction as it proceeds, for example adding information about the order placed, amount owing, other transaction details, etc as it becomes available, associating all such information with that transaction's TIC.

When TIC 16 is received by server 10, it is then communicated to vendor sales system 12. Vendor sales system 12 then compares TIC 16 to TIC database 22 at step 31 to ensure that TIC 16 as entered matches a TIC which is available to be used. If TIC 16 is determined not to be available, vendor sales system 12 transmits an error notice to server 10 in step 33. Server 10 then transmits the error notice to mobile device 4 and requests re-entry of TIC 16 (step 35). The consumer re-enters TIC 16 at step 37 and the new entry is transmitted to server 10 in step 39. Server 10 transmits TIC 16 back to vendor sales system 12 at 41 and the TIC verification process continues at step 31 until TIC 16 is confirmed as correct. Although not shown, a terminate process could be added to allow the verification process to be terminated either after a certain number of iterations or by a manual ‘terminate’ command.

If TIC 16 is confirmed as available, vendor sales system 12 can additionally determine whether any preliminary action needs to be taken in that vendor's particular environment to allow the transaction to proceed before returning to the further processing of step 13 in FIG. 2. Examples of possible preliminary actions that may occur in certain environments are provided below.

As noted above, loyalty card or benefit program information represents another category of transaction options. Accordingly, in one embodiment, part of the account set-up process provides the opportunity for the consumer to enter loyalty card numbers associated with the vendor, which eliminates the need for a consumer to carry the loyalty card. In such a case, server 10 transmits this information, as part of the selected transaction option information, to vendor sales system 12 at step 11 for processing the loyalty benefits. In some vendor transaction systems, it is possible that a separate loyalty card system is used, in which case, server 10 is suitably interfaced to such separate loyalty card system.

hi some embodiments, it is possible to use the loyalty card as a payment facility. The loyalty card is included in the list of possible payment facility choices sent to the consumer during step 17 of FIG. 3. Alternatively, in another embodiment, the server 10 is configured to query vendor sales system 12 to retrieve information relating to the loyalty card before step 9 and include it as a payment facility choice only if the balance or status of the card is sufficient.

In one embodiment, server 10 is configured to query vendor sales system 12 for loyalty card information to be transmitted to mobile device 4 simply for informational purposes, such as to allow the consumer to check their loyalty card information (e.g. point balances, number of transactions made or number of transactions remaining until a benefit, such as a free product or service).

In a further embodiment, any promotions or special offers available at the vendor are communicated to the consumer upon initiation of application 8. For example, a button or other input method initiates the display of the promotions. In an alternate embodiment, the consumer is required to view each promotion before application 8 allows TIC 16 to be entered. Some embodiments provide the ability to use a promotion on a financial transaction. The promotion may include a promo code that the consumer has the option to enter during the financial transaction method.

Promotions can be general promotions or promotions tailored to the consumer. This tailoring is done based on transaction history, order or payment options, current transaction information, demographic or based on any other personal information.

As can be appreciated from the above description and the following examples, mobile device 4 and server 10 cooperate with vendor sales system 12 to initiate and further conduct a transaction. A transaction initiation code 16 is input into mobile device 4 and pertinent transaction options are selected by the consumer. Server 10 communicates TIC 16 and the selected transaction option(s) to vendor sales system 12 to allow vendor sales system 12 to execute its otherwise normal steps for conducting a transaction.

Several examples of different embodiments of the invention in different environments are described below. These include a general financial transaction, a dine-in restaurant, a drive-through restaurant, a full service gas station, a self-service gas station and an entertainment facility.

### General Financial Transaction

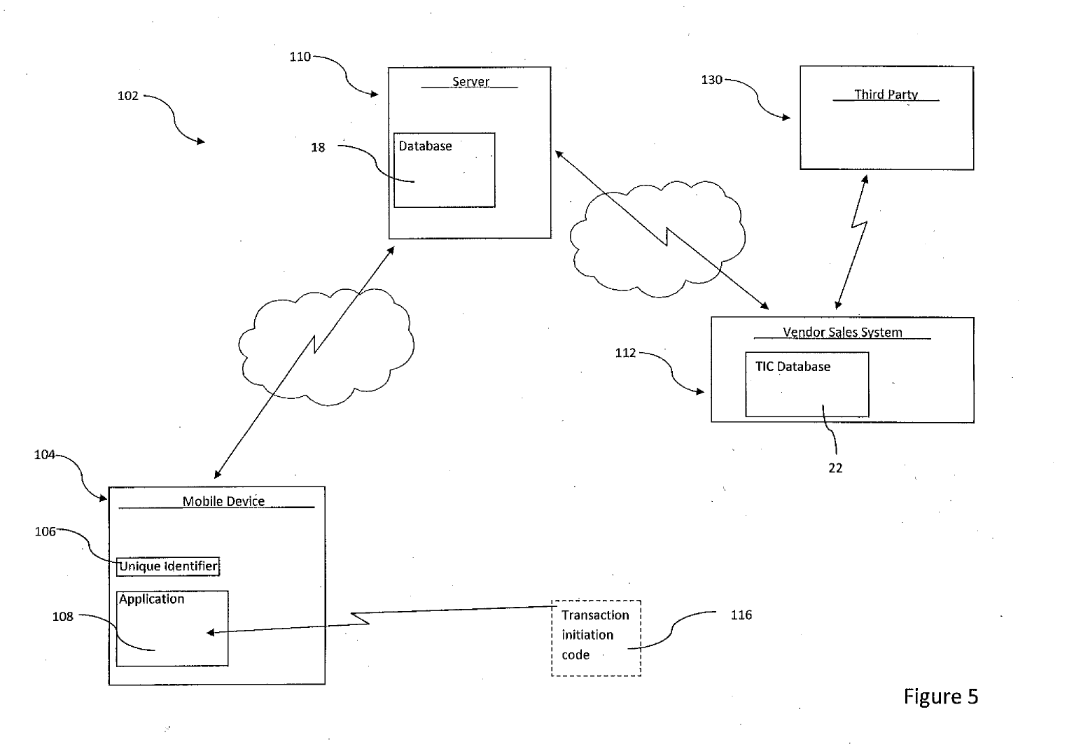

FIG. 5 is a depiction of the system of the invention for use in conducting financial transactions. System 102 includes a mobile device 104 having a unique identifier 106 and an application 108 associated with the vendor. System 102 includes a server 110, associated with the vendor, containing or connected to a secure database 18 of the unique identifiers 106 of mobile devices 104 and payment facility information corresponding to each of the unique identifiers 106 of the mobile devices 104. Server 110 is capable of receiving signals from and transmitting signals to a mobile device 104. System 102 also includes vendor sales system 112 which receives signals from and transmits signals to server 110. Vendor sales system 112 further includes a TIC database 22. Vendor sales system 112 is capable of communicating with a third party financial institution 130, such as a bank, credit card company or any other institution associated with payment facilities. Third party financial institution 130 can authorize payments made via one or more payment facilities.

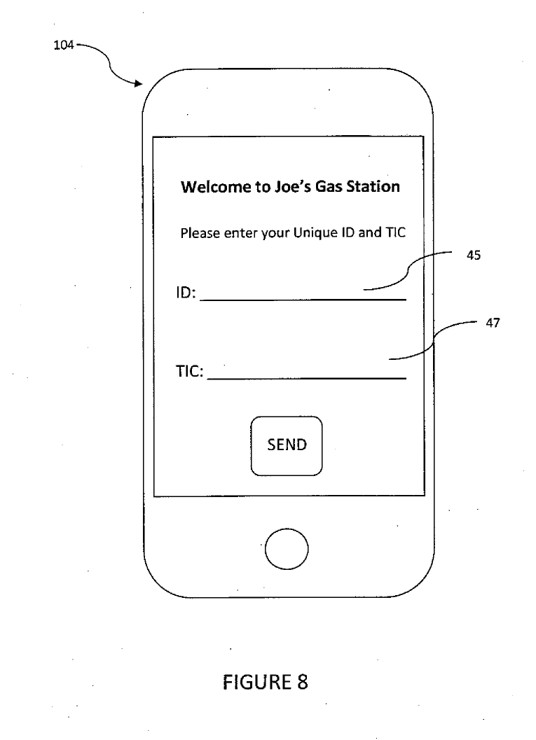

In many embodiments, the method and system of the invention are used to conduct a financial transaction between a mobile device 4 and a vendor sales system 112. Referring to FIGS. 2, 3, 6A-B and 7, a financial transaction is started when the consumer initiates application 108 (step 1) on mobile device 104 which is associated with a unique identifier 106. The vendor provides a TIC 116 at step 3. In step 5, TIC 116 is input into application 108. FIG. 8 illustrates an example screenshot from step 5 on mobile device 104. This depicts an initiation page prompting the consumer to enter both a unique identifier 106 at 45 and a TIC 116 at 47. Application 108 uses mobile device 104 to transmit TIC 116 and unique identifier 106 of the mobile device 104 to the server 110 (step 7). In this embodiment, the transaction options are payment facility options and, in step 9, the desired payment facility is selected. Server 110 then transmits the details of the selected payment facility information and TIC 116 to vendor sales system 112 in step 11. In step 13, vendor sales system 112, using the payment facility information and TIC 116, then processes the transaction to settle the account. In a preferred example, vendor sales system 112 uses TIC 116 to associate the transaction details (e.g. price) with the selected payment facility and thereafter processes the payment.

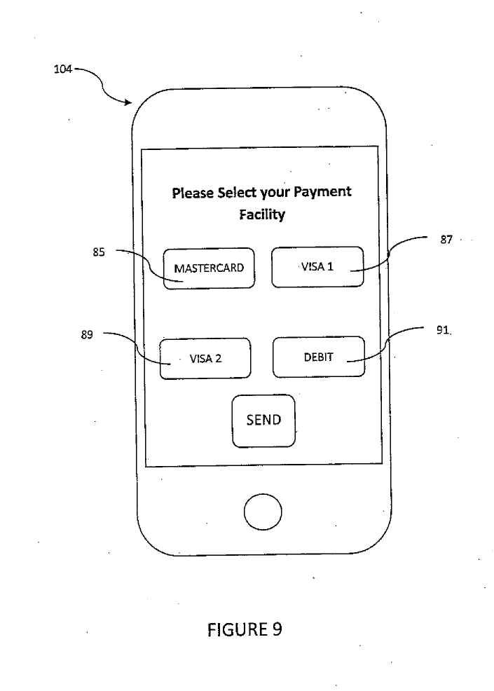

Referring to FIG. 3, an example is provided for the determination of the transaction option. In this embodiment, the consumer has pre-recorded in database 18 the details of one or more payment facilities that the consumer may wish to use. Server 110 receives the unique identifier 106 for the mobile device 104 being used and retrieves from database 18 the pre-recorded payment facilities associated therewith. If only one payment facility has been pre-recorded, then there is no need for the consumer to make a selection and accordingly, in step 25, the one pre-recorded payment facility is selected as the payment facility to be used for the transaction. If multiple payment facilities have been pre-recorded, in step 17, server 110 transmits corresponding payment facility labels to application 108 on mobile device 104. A payment facility label is used to identify each payment facility to the consumer, for example by identifying the card brand or displaying the last four numbers of the card. It is preferred for security reasons that the full card number not be transmitted to mobile device 104 to ensure that no such specific financial information is stored in mobile device 104 or intercepted during transmission. Application 108 displays the labels associated with the various choices and in step 19 the consumer enters their preferred choice. A screenshot of this portion of the method is illustrated in FIG. 9. This screen shows four example labels for payment facilities including a “MasterCard” label 85, a first “Visa” label 87, a second “Visa” label 89 and a “debit” card label 91. This choice is transmitted by mobile device 4 in step 21 to server 110. Server 110 in turn transmits the necessary full details for the selected payment facility to vendor sales system 112 at step 11 for further processing in step 13.

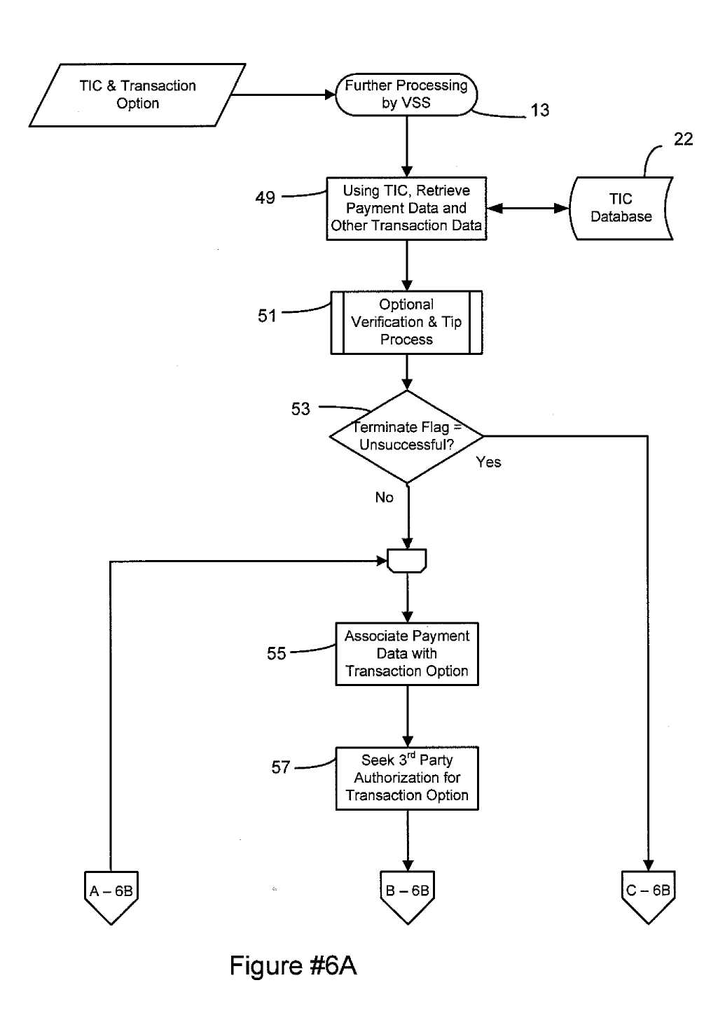

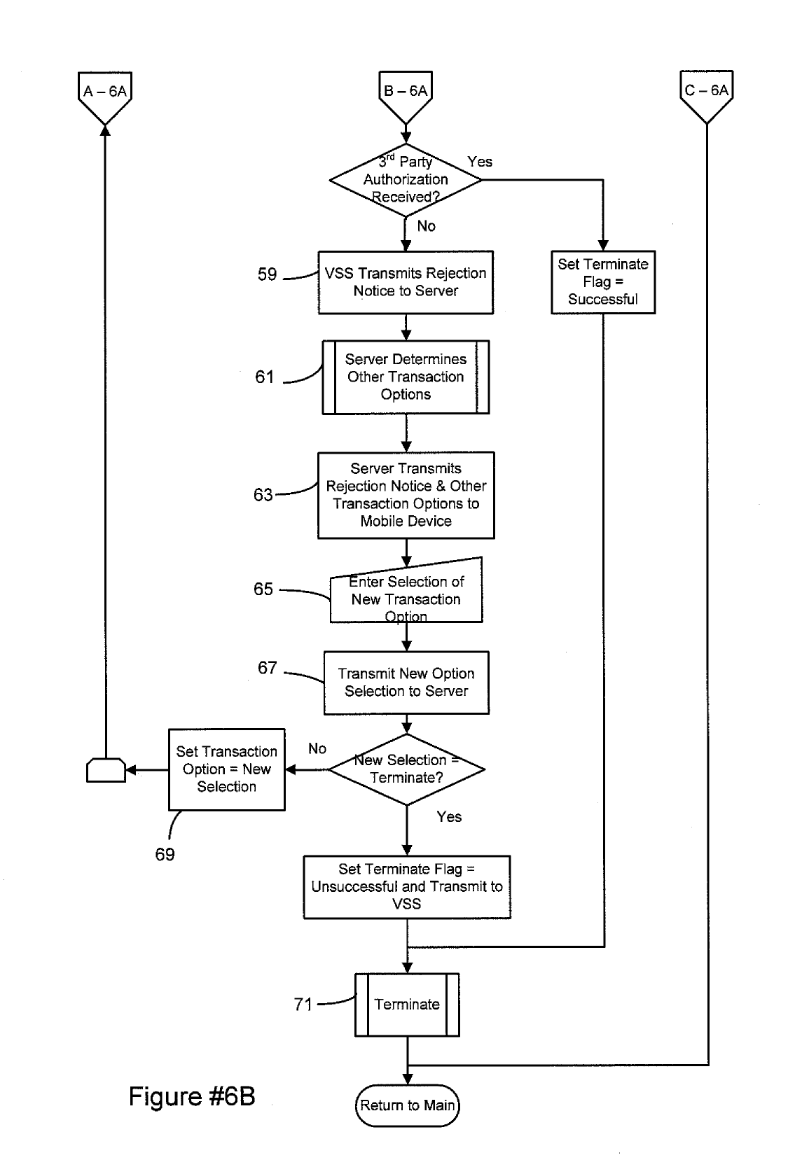

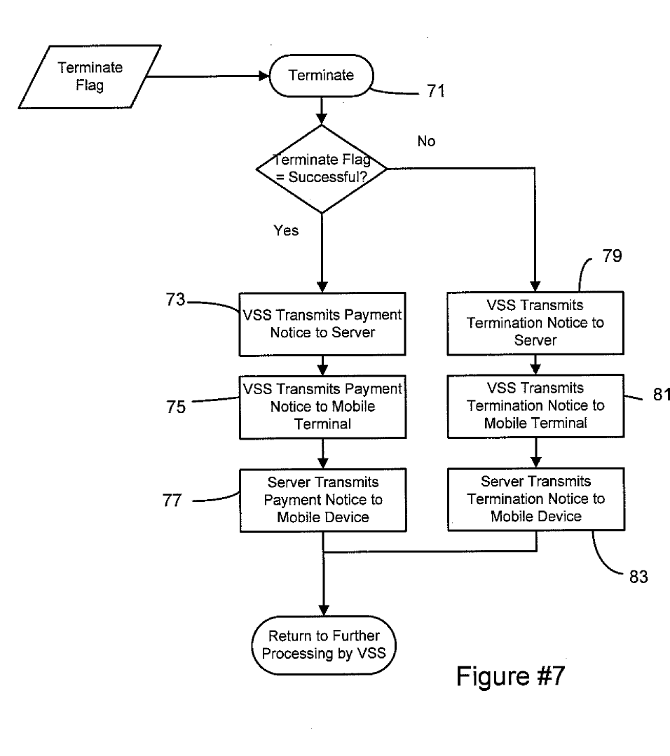

Examples of some further processing for step 13 are shown in FIGS. 6A-B and 7, in which the abilities to allow third party 130 authorization of the settlement of the transaction or to provide notices of success or failure of the transaction to server 110 and/or mobile device 104 are added. Using TIC 116, vendor sales system 112 retrieves or identifies transaction details such as payment data (step 49). At, this point, in some embodiments, an optional verification and tip process 51 (described in detail below) is added. Thereafter, unless the transaction is to be prematurely terminated by the optional verification and tip process 51 (again as described in detail below), the payment data is associated with the specified transaction option (in the present example, the specified payment facility) at step 55. In step 57, vendor sales system 112 seeks authorization in the normal manner from a third party 130 associated with the specified payment facility (for example, the particular bank, credit card company or other financial institution). Vendor sales system 112 can track the success of the payment using a variable called “Terminate Flag”, which can be set to “successful” if the payment is authorized by the third party 130 or to “unsuccessful” if the payment is declined by the third party 130. If authorization of the payment is received (i.e. the “Terminate Flag” is set to “successful”), the method continues through a transaction termination process 71 in which at step 73 of FIG. 7 acknowledgment of the successful payment is transmitted to server 110. Server 110 can then optionally notify the consumer by transmitting an acknowledgement of payment to application 108 for display on mobile device 104 at step 77.

At this point, in some embodiments, the system includes the feature of providing electronic receipts to the consumer (not shown in Figures). In such an embodiment, server 110 receives the transaction data from vendor sales system 112 and stores such data, associated with the consumer's account, for example in the form of an electronic receipt in database 18. In this embodiment, application 108 permits the consumer to access their transaction history and/or electronic receipts. Alternatively, an email could be entered during the consumer's account set up procedure to allow the electronic receipts to be sent to the consumer via email either upon request or automatically on a periodic basis or after each transaction. In one embodiment, access to the e-receipts and transaction history, which are stored in database 18, are also provided in other manners, such as over the internet.

Referring back to FIGS. 6A-B, if authorization of the payment is not received or is declined (i.e. the “Terminate Flag” is set to “unsuccessful”), the method continues at step 59, in which vendor sales system 12 transmits a rejection notification to server 110. In step 61, server 110 determines if there are any other transaction options (again, in this case, payment facility options) and transmits notification of the rejection and other transaction options to application 108 via mobile device 104 at step 63. Application 108 receives the notification and displays two options at step 65—either select a new transaction option (i.e. in this case, another payment facility) or terminate the payment. If the consumer decides to select a new transaction option, the process continues at steps 69 and 55 using the newly selected payment facility. To provide the option for the consumer to retry the payment with the same payment facility that failed, the failed payment facility could be included in the transmission of other transaction options in step 63. If the consumer decides to terminate the transaction, server 110 sets the “Termination Flag” to “unsuccessful” and transmits same to vendor sales system 112. The method continues at step 79 of FIG. 7. At step 79, vendor sales system 112 transmits a termination notice to server 110 and server 110 transmits such notification to mobile device 104 at step 83.

In some applications, such as a dine-in restaurant or a full serve gas station, it is desirable for a staff member to track the payment status of the consumer through a remote staff terminal such as a remote mobile terminal. In some embodiments, the remote mobile terminal is a mobile device, such as a mobile phone, tablet or any other mobile device. In other embodiments, the remote staff terminal is a fixed terminal such as a computer, printer terminal, or other electronic device. In one embodiment, the remote staff terminal is specific to the staff member, while in other embodiments it is shared by more than one staff member. As part of the termination process shown in FIG. 7, the remote terminal can be notified of the success of a payment (at step 75) or the failure of a payment (at step 81).

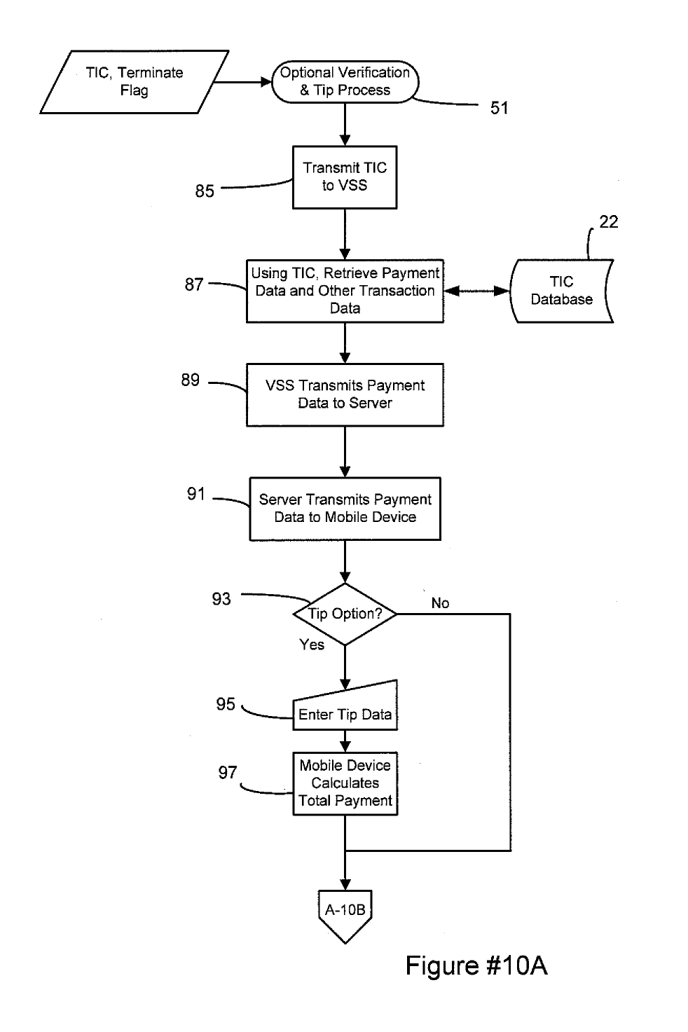

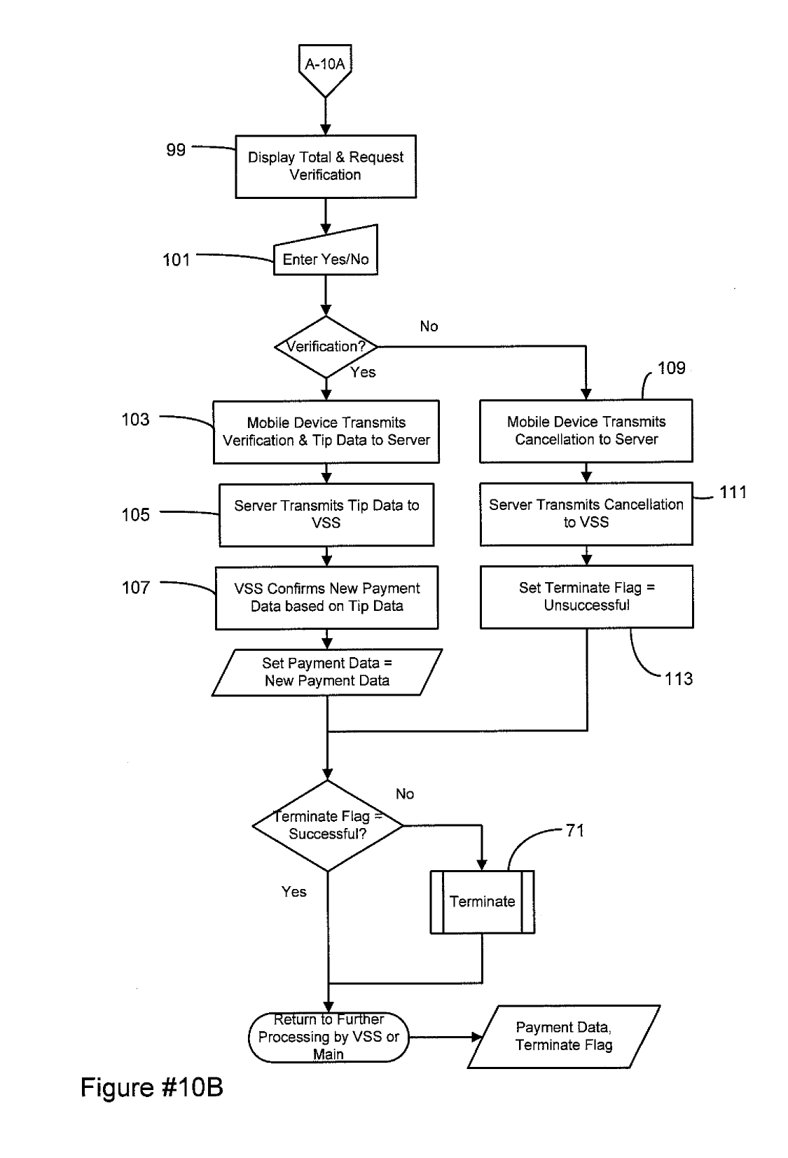

As noted above, the method additionally allows for, and FIGS. 6A-B show, an optional verification and tip process 51 as part of further processing step 13. FIGS. 10A-B illustrate an example of such verification and tip process 51. The price verification procedure allows the consumer to approve the final price before completing the transaction which can be particularly important in the context where a tip has been added by the consumer to the amount to be paid. Additionally, this gives the consumer an opportunity to confirm visually that the price is as expected. If the price is or seems wrong, it may indicate that there has been a problem with the transaction. For example, the intended purchase may have been associated by the vendor's staff with the wrong TIC in the vendor sales system 112 or TIC 116 may have been entered incorrectly by the consumer and incorrectly associated with another person's transaction. In any event, the verification and tip process 51 allows the consumer to cancel the transaction and resolve the problem with the vendor's staff before attempting to proceed further with the transaction.

Referring to FIGS. 10A-B, at step 87, vendor sales system 112 uses TIC 116 (transmitted at step 85) to retrieve the transaction details, including the amount owing or payment data. At step 89, vendor sales system 112 communicates the payment data back to server 110, which in turn at step 91 transmits same back to application 108 via mobile device 104. If the situation is appropriate, an optional tip option 93 can be employed to add a tip to the amount owing in steps 95 and 97. The tip data is entered in step 95. The tip is entered in any suitable form including a fixed monetary amount chosen by the consumer, a percentage of the amount owing or a selection of amounts pre-set by the system or any other suitable form. The total payment including the amount owing and tip (calculated in step 97) is displayed by application 108 in step 99, allowing the consumer to review and verify the purchase at step 101. If the amount is verified, mobile device 104 transmits the verification back to server 110 in step 103 and in turn server 110 transmits the verification (and any tip data) back to vendor sales system 112 in step 105. Vendor sales system 112 calculates the new payment details including the tip in step 107. Further processing then continues in step 13 in FIGS. 6A-B.

If the consumer does not provide verification at step 101, mobile device 4 transmits a cancellation notice to server 110 at step 109 and server 110 transmits the cancellation notice to vendor sales system 112 at step 111. The “Terminate Flag” variable is set to “unsuccessful” at step 113 and the method continues at step 71 of the terminate process set out in FIG. 7 to terminate the transaction.

In some embodiments, it is preferable to include the verification and tip process earlier in the method, for example, after transmitting TIC 116 and unique identifier 106 of mobile device 104 to server 110 in step 7 of FIG. 2. This is particularly useful when the consumer is not aware of the final price of the product (such as after a meal at a dine-in restaurant or after filling a vehicle with gas at a full serve station). Including the verification and tip process here allows the consumer to check the price before having to decide which payment facility they would like to use in step 9. Examples of this are outlined below in the dine-in restaurant and full serve gas station examples.

This system and method of completing a financial transaction is advantageous in that the sensitive payment facility information is not stored in the mobile device, but is associated with the information stored in database 18 associated with server 110. Thus, should the mobile device be lost, the consumer is not in danger of having their payment facility information compromised. Further security features such as requiring a personal identification number to be entered upon initiation of the application or requiring the input of a personal identification number corresponding to the chosen payment facility can be added to increase security.

### A Dine-In Restaurant

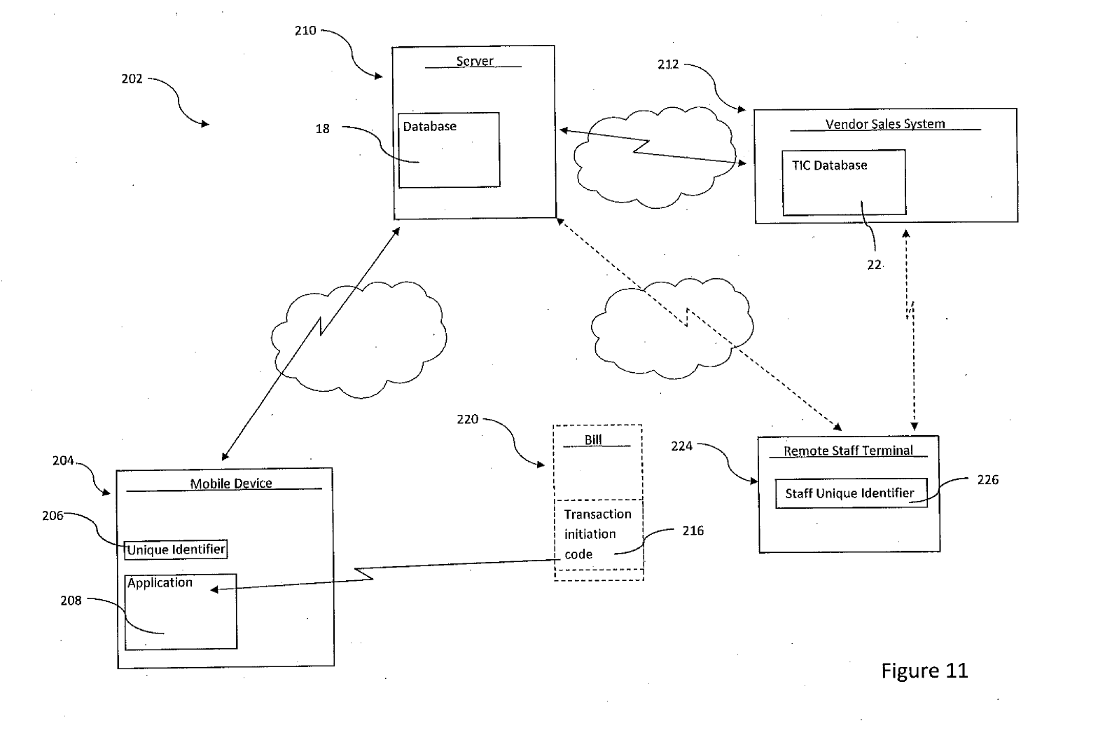

FIG. 11 is a depiction of the system of the invention in use in a dine-in restaurant. System 202 includes a mobile device 204 having a unique identifier 206 and an application 208 specific to the restaurant or restaurant chain. System 202 includes a server 210, associated with the restaurant or restaurant chain, containing or connected to a secure database 18 of the unique identifiers 206 of mobile devices 204 and payment facility information corresponding to each of the unique identifiers 206 of the mobile devices 204. Server 210 is capable of receiving signals from and transmitting signals to mobile device 204. System 202 also includes vendor sales system 212 which receives signals from and transmits signals to server 210. Vendor sales system 212 further includes a TIC database 22.

In some embodiments, an optional remote staff terminal 224 is used in combination with this system to notify the attendant or vendor of the payment status. Remote staff terminal 224 is a mobile device specific to the attendant or vendor, a fixed device such as a computer, printer station, screen or any other device capable of receiving transmission from vendor sales system 212 or the server 210. In an alternate embodiment, vendor sales system 212 further includes a feature to allow the vendor to track consumers' payments either directly or indirectly via server 210.

A bill 220, containing the transaction initiation code 216 in any acceptable form, is associated with the transaction.

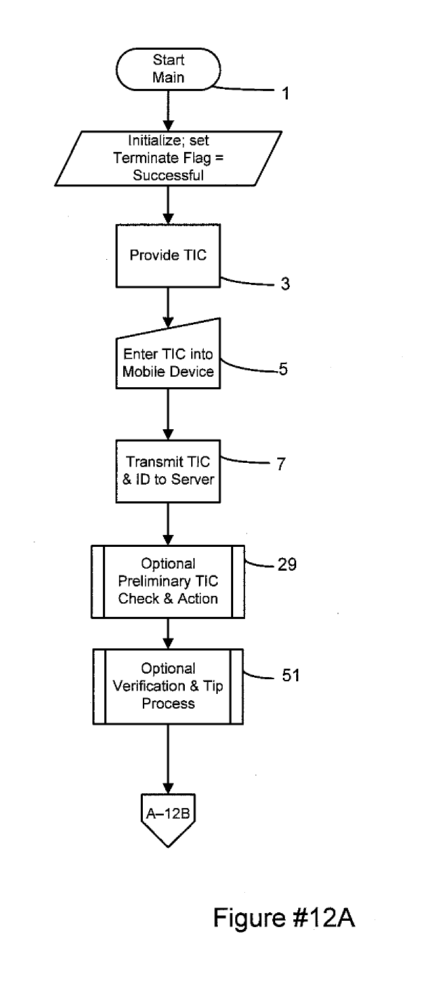

Referring to FIGS. 12A-B, the consumer uses mobile device 204 to initiate the application 208 in step 1 corresponding to the restaurant or restaurant chain in which they are dining. TIC 216 is provided by the restaurant when bill 220 is delivered in step 3 to the consumer. Input of TIC 216 into application 208 is completed at step 5. Application 208 uses mobile device 204 to transmit TIC 216 and unique identifier 206 of mobile device 204 to server 210 at step 7. At this point, in some embodiments, the optional TIC check 29, as outlined in FIG. 4, is used to ensure that TIC 216 was entered correctly.

Next, the verification and tip process 51, as outlined in FIG. 10A-B, is used to verify the price and add a tip for the wait staff. Server 210 transmits TIC 216 to vendor sales system 212 at step 85. Using TIC 216, vendor sales system 212 recalls the payment data, specifically the amount owing in this embodiment, from TIC database 22 at step 87. Vendor sales system 212 transmits the payment data to server 210 in step 89. At step 91, server 210 in turn transmits the payment data to mobile device 204. Application 208 provides the option to add a tip at step 93.

If the consumer decides to add a tip, they enter the tip data at step 95 and mobile device 204 calculates the total that is owing including the tip at step 97. The total is then displayed on mobile device 204 and verification is requested at step 99. Should the consumer decide not to add a tip at step 93, the payment data (in such case, only the basic amount owing without any added tip) is displayed and verification is requested at step 99.

If verification is given at step 101, mobile device 204 transmits the verification and tip data to server 210 at step 103. Server 210 then transmits the tip data to vendor sales system 212 (step 105). A total is calculated by vendor sales system 212 based on the tip data at 107.

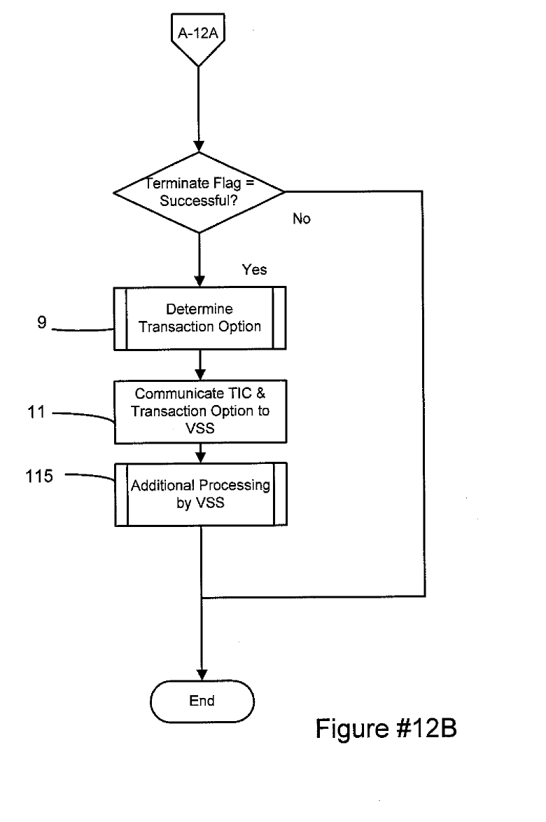

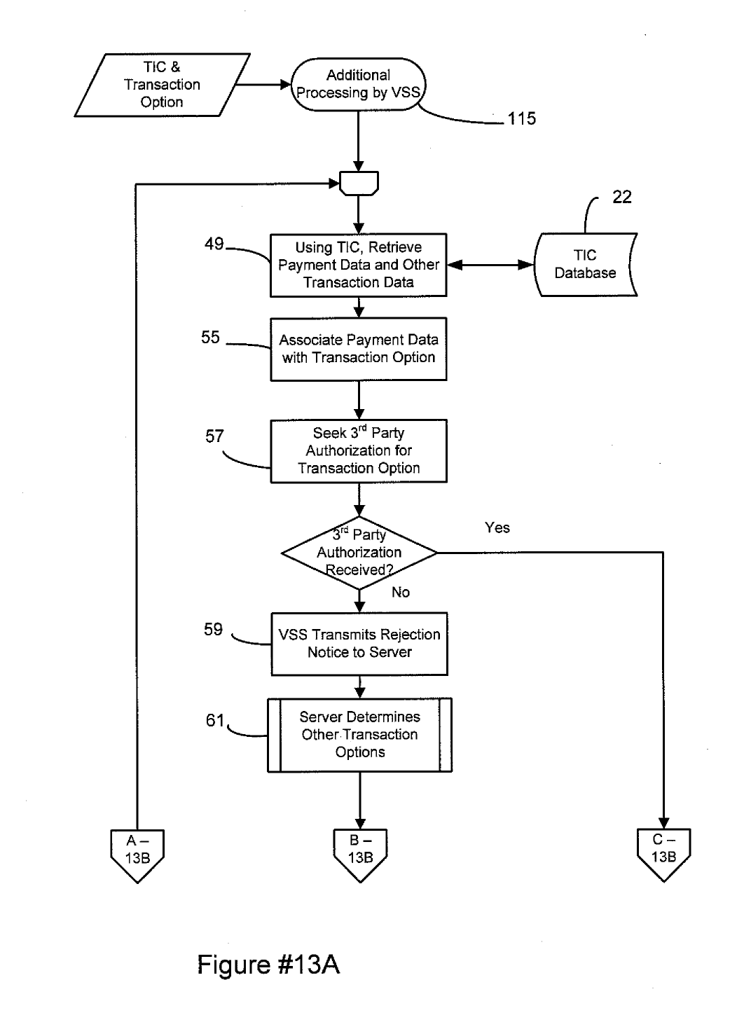

Since verification was received, the process continues on in step 9 to determine the payment facility the consumer would like to use. This is determined according to the process set out in FIG. 3. TIC 216 and the details of the selected payment facility are transmitted to vendor sales system 212 in step 11 of FIG. 12A-B. Additional processing by vendor sales system 212 occurs at step 115. This additional processing is outlined in FIGS. 13A-B and ends in a successful payment process or early termination of the transaction. The steps outline in FIGS. 13A and 13B are similar to those in the further processing process shown in FIGS. 6A-B and each step includes a reference number corresponding to the similar step in FIGS. 6A-B.

If the consumer did not verify the total at step 161 in FIG. 10A-B, mobile device 204 transmits a cancellation message to server 210 at step 109. Server 210 transmits the cancellation message to vendor sales system 212 in step 111, the transaction flag is set to “unsuccessful” at step 113 and the transaction is terminated in accordance with the method outlined in FIG. 7.

As shown in FIG. 11, the system and method of the invention can be adapted in an alternate embodiment to include a remote staff terminal 224 to allow the wait staff to track payment statuses. Such an embodiment provides suitable notices, including acknowledgement of the successful settlement of the transaction or failure of the transaction, to the wait staff, allowing them to track the payment status of all their tables. To integrate this into the method, TIC 216 includes a staff unique identifier 226 associated with the remote staff terminal 224 to be used by server 210. When server 210 receives acknowledgement of payment at step 73 of FIG. 7, server 210 transmits this acknowledgement to remote staff terminal 224. Similarly, server 210 sends other payment updates, such as a notice of termination of the payment, a notice that the consumer will try a different payment facility or a notice that the consumer will retry the payment to the wait staff. In an alternate embodiment, a remote staff terminal 224 in the form of a computer is placed in a location where all the wait staff can access it. This remote staff terminal 224 receives all the notifications for all the tables in the restaurant and each wait staff member can check the payment statuses of their tables at the remote staff terminal 224. In another version of this embodiment, the communications to remote staff terminal 224 are managed by or through vendor sales system 212.

This system and method allows for a simplified payment procedure. Conventionally, the bill is brought to the consumer and the consumer must indicate their preferred method of payment to the wait staff. In the case of using a credit card to pay, the wait staff leaves the table to process the card at a financial transaction system and brings a receipt for the consumer to sign. Alternatively, the wait staff retrieves a remote bank terminal to allow the consumer to pay at the table. In both cases the payment is initiated by the vendor sales system 212. By allowing the consumer to initiate the transaction using a transaction initiation code, the steps of retrieving a portable financial transaction system or processing the transaction and returning to the table with a receipt are eliminated.

### Drive-Through Restaurant

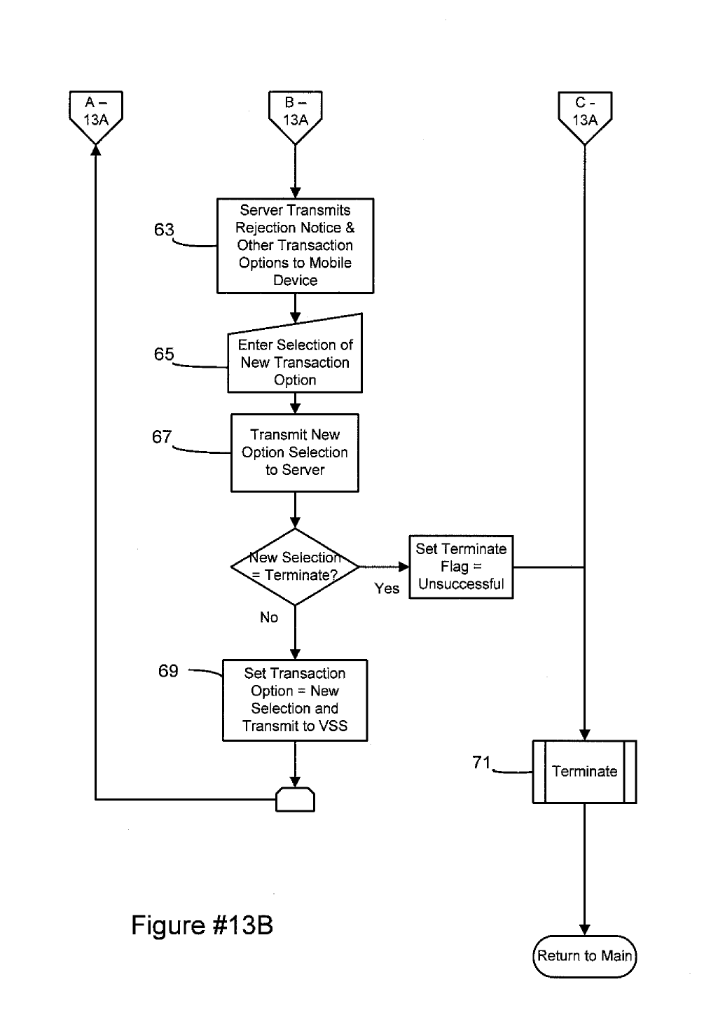

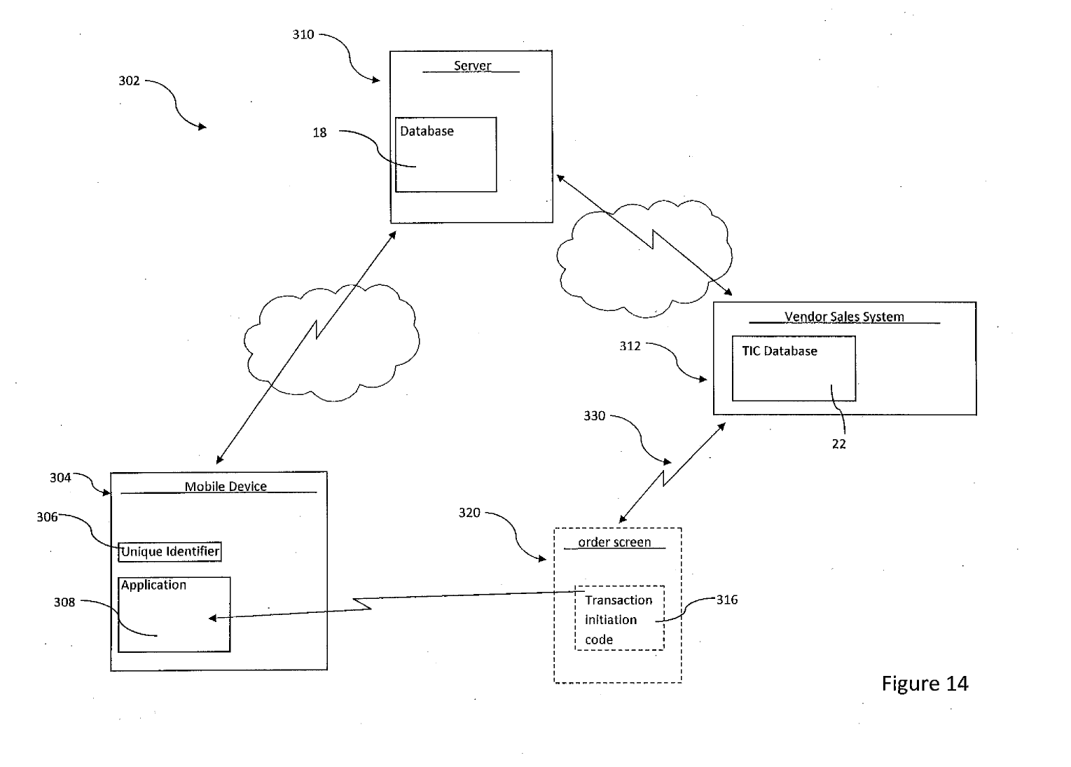

The method and system of the invention can be implemented at a drive-through restaurant where the consumer can place their order through the application in their mobile device. In such embodiment, the transaction system 302 (shown in FIG. 14) includes a mobile device 304, with a unique identifier 306 and an application 308 associated with the restaurant or restaurant chain. System 302 further includes a server 310, also associated with the restaurant or restaurant chain, containing or connected to a database 18 of the unique identifiers 306 of mobile devices 304 and menu preferences pre-recorded by the consumer. Additionally, database 18 may have a transaction option category of payment facility information corresponding to the unique identifiers 306 of the mobile devices 304. Server 310 is capable of receiving signals from and transmitting signals to mobile device 304. System 302 further includes a vendor sales system 312 that can receive signals from and transmit signals to server 310. Vendor sales system 312 further includes a TIC database 22. Included in system 302 is an arrangement 330 for communicating a TIC 316 from vendor sales system 312 to the customer. For example, the arrangement 330 could comprise an order screen 320 linked by a communication channel 330 to vendor sales system 312 whereby to allow TIC 316 to be displayed on screen 320. The system also includes any desired physical structures (not shown), such as curb barriers, to ensure that customers remain in a sequential queue in the order in which they engaged system 302. TIC 316 could be displayed as soon as a previous order is processed or triggered by a vehicle sensor.

In this embodiment, TIC 316 uniquely identifies each order and sequentially used TICs represent sequential customer orders in a queue. The use by a consumer of a TIC 316 additionally confirms to the vendor that the consumer is physically present in the drive-through lane at a particular position in the queue. This prevents orders from being placed prior to arrival at the restaurant and ensures that the correct order is picked up by the consumer and is fresh/hot at the time of pick up.

The drive-through restaurant embodiment includes additional account set up procedures to allow the consumers to record preferred menu choices. These pre-recorded menu choices are stored in database 18 as transaction options. Menu options can include part of, or the entirety of, the restaurant's menu. Order options may include a single item or a combination of items. Using a typical coffee shop as an example, one order may be a breakfast option of coffee and a donut; a second order may be an alternative breakfast option of tea and a muffin; and a third order option may be a lunch order of a sandwich and a soda. In some embodiments, order options are preset based on the restaurant's most popular orders or are specific to the consumer. The account set up website allows these consumer-specific options to be recorded. Alternatively, order options could be recorded at a restaurant location using mobile device 304. For example, the consumer places an order and an employee enters the order into vendor sales system 312, all in the traditional mariner. When the order is complete, vendor sales system 312 is equipped to transmit the order information back to mobile device 304 through known technology, such as RFID or NFC. In turn, mobile device 304 communicates the order information to server 310 to be stored in the database 18 and the order information can be later recalled using the unique identifier 306 of the mobile device 304. As an alternative, application 308 is configured to store the order information for future visits to upload to server 310 as required.

The method of placing an order at a drive-through restaurant is shown in FIG. 15. In this example, the consumer uses application 308 to place an order using their mobile device 304 and completes the financial transaction in a conventional manner. In this embodiment, the consumer initiates the transaction by opening application 308 on their mobile device 304. The vendor supplies a dynamic TIC 316 specific to the order at step 117, for example by displaying same on an order screen 320 or in any other suitable manner. Using mobile device 304, at step 119, the consumer enters TIC 316 into application 308. At step 121, TIC 316 and unique identifier 306 of mobile device 304 are transmitted to server 310. At this point, TIC 316 can optionally be verified using the optional preliminary TIC Check and action process outlined in FIG. 4. For this particular embodiment, no preliminary action (step 43) would be required.

Step 123, determining the transaction option, occurs as in FIG. 3. In this embodiment, the transaction option to be determined is an order chosen from pre-determined orders previously recorded in database 18 by the consumer. TIC 316 and the chosen order are then transmitted from the server 310 to vendor sales system 312 for further processing. In a preferred version of this embodiment, the vendor sales system 312 may include a fully integrated point of sale system whereby the further processing includes the direct entry of the order information communicated from server 310 into the vendor's point of sale system for additional processing. In some cases, the further processing may consist merely of displaying the order on a vendor sales system 312, such as a display terminal, which a staff member can examine so as to prepare the order and/or manually enter the order into the vendor's point of sale system.

The ability to store order preferences and place an order through a mobile device provides an opportunity for more accurate and quicker ordering compared to conventional systems where the order is communicated through a speaker and microphone apparatus located outside the drive-through restaurant. Conventional systems are sensitive to communication errors and require a staff member to receive the orders. The system and method in this embodiment eliminate the need to communicate an order orally, thus potentially reducing time-consuming oral communications and communication errors.

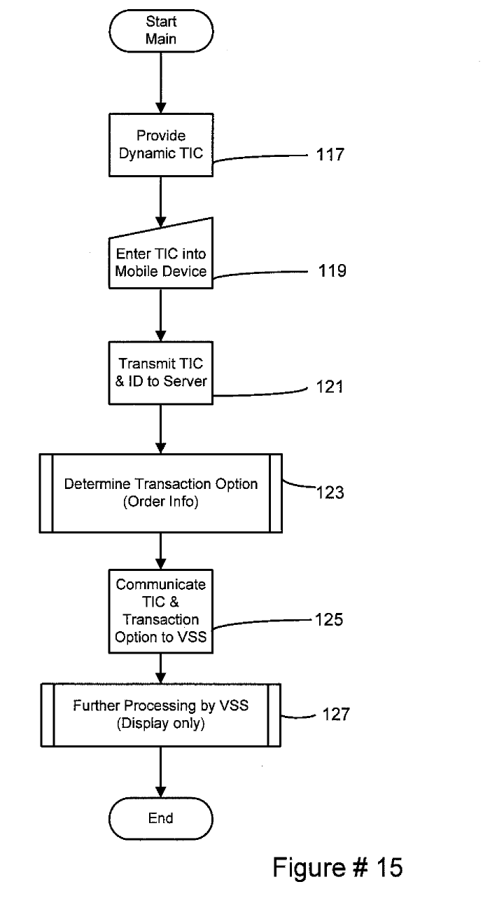

In some contexts, it is desirable to have multiple transaction option categories. In one such example, the method and system of the invention is used both to place an order and to pay for the order at a drive-through restaurant. The method follows the steps set out in FIGS. 16 and 17. A consumer initiates application 308 in step 129 and drives up to the order screen 320 where in step 131 the vendor provides a dynamic TIC 316 specific to the order. In step 133, the consumer inputs the dynamic TIC 316. In step 135, TIC 316 and the unique identifier 306 of mobile device 304 are transmitted to server 310. In step 137, in this example, two categories of transaction options are to be determined—a payment facility preference and an order preference. In step 143, all the transaction options are retrieved from database 18.

Within the order options category, an order preference is determined as set out in steps 147 to 153, analogous to steps 17 to 23 previously described. Once the order preference has been determined, the server 310 checks for any other transaction options that need to be addressed (step 157). In this example, the payment facility preference needs to be determined. This is done by repeating steps 147 to 153 in the context of the payment facility options. Once all the transaction option categories have been addressed and a selection made for each category, the method continues at step 139 of FIG. 16. These preferences for each transaction option are transmitted back to the vendor sales system at step at 139 and further processing occurs (step 141).

In an alternative embodiment, both the payment facility options and the order options are retrieved by server 310 and transmitted to the mobile device 304 in one transmission. The consumer then enters both their order preference and their payment facility preference before both preferences are transmitted back to the server 310 and subsequently to the vendor sales system 312 (step 139) for further processing (step 141).

Although this particular example included two particular types of transaction option categories, it can be appreciated that any number of transaction option categories of any type can be determined using this method.

### Full Service Gas Station

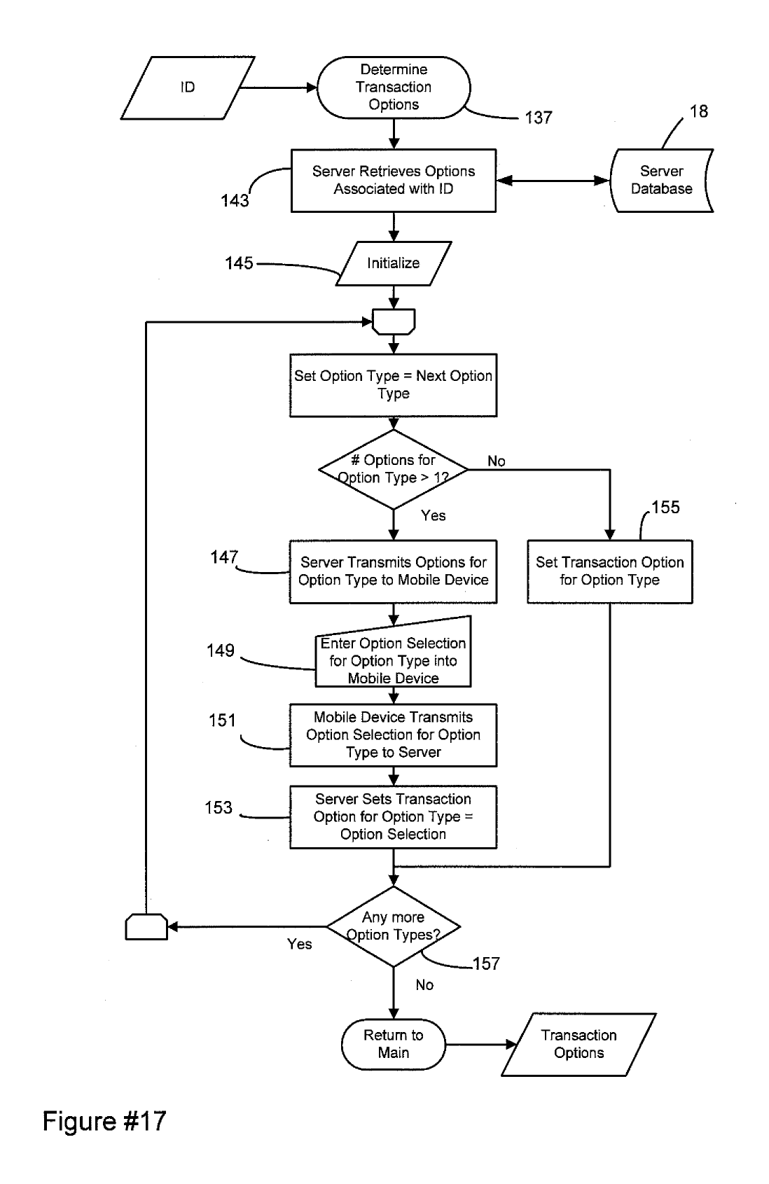

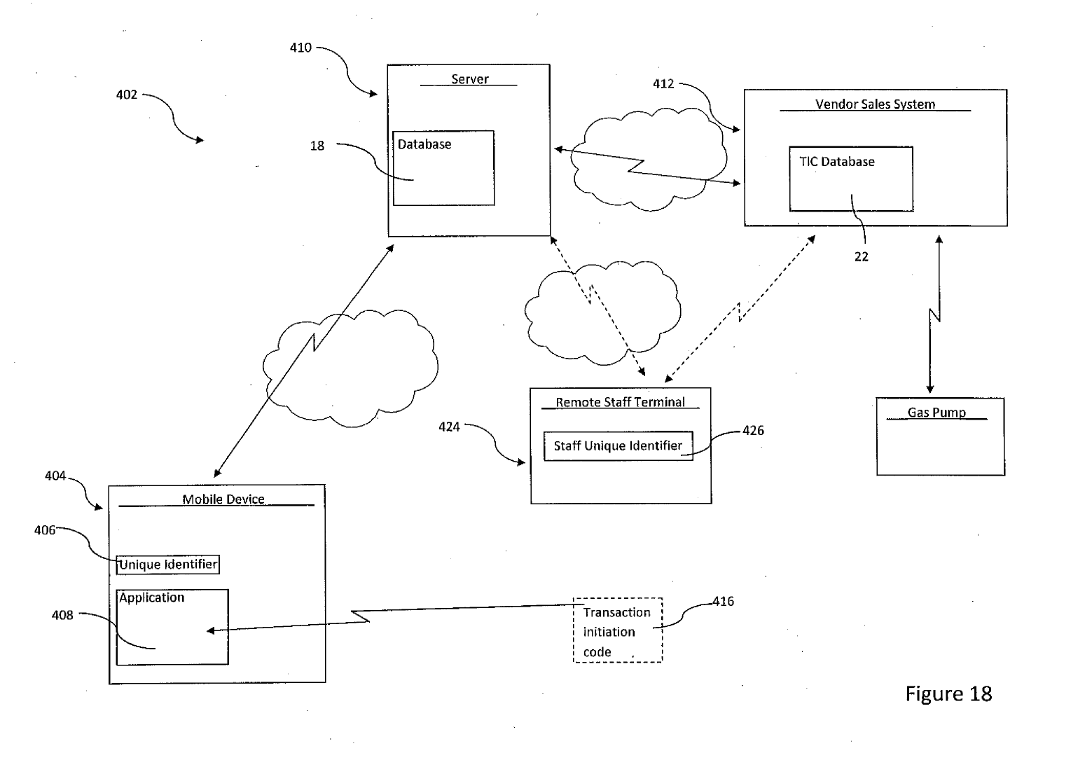

The method and system can also be implemented at a gas station providing a full service option. In this embodiment, the system 402, depicted in FIG. 18, includes a mobile device 404, with a unique identifier 406 and an application specific to the gas station or gas station chain 408. It further includes a server 410, also specific to the gas station or gas station chain, containing a database 18 of the unique identifiers 406 of mobile devices 404 and transaction options (in this case, payment facility options) corresponding thereto. Server 410 is capable of receiving signals from and transmitting signals to mobile device 404. System 402 further includes a vendor sales system 412 that can receive signals from and transmit signals to server 410. Vendor sales system 412 further includes a TIC database 22 in which transaction information associated with each TIC 416 is stored.

In one embodiment, an optional remote staff terminal 424 is used in combination with this system to notify the attendant or vendor of the payment status. Remote staff terminal 424 is a mobile device specific to the attendant or vendor, a fixed device or any other device capable of receiving transmission from server 410 or from vendor sales system 412 or the server 410. In an alternate embodiment, vendor sales system 412 further includes a feature to allow the vendor to track consumers' payments either directly or indirectly via server 410.

Referring to FIGS. 2, 3 and 6A-B, when in position at the pump, the consumer initiates application 408 in step 1. The vendor provides a dynamic or static TIC 416 to the consumer in step 3. A dynamic TIC 416 can be displayed on the screen of the pump or a supplemental screen; a static TIC 416 can be presented on a sign specific to the pump. TIC 416 is input into application 408 in step 5 and mobile device 404 transmits it to server 410 in step 7. The consumer selects their payment facility using the method set out in FIG. 3. Using the unique identifier 406 of mobile device 404, server 410 retrieves the pre-recorded payment facility options from database 18 in step 15. The consumer selects their preferred payment facility in steps 17, 19 and 21. The details of the selected method of payment and TIC 416 are transmitted to vendor sales system 412 in step 11 (FIG. 2) and further processing occurs to settle the transaction at step 13.

An optional verification process 51 could be completed before determining the transaction options. This process is identical to the method disclosed in the dine-in restaurant example and allows the consumer to review their final price before determining which payment facility they would like to use.

As in the dine-in restaurant example above, in some embodiments, such as the full service gas station, it may be desirable to send a notification to remote staff terminal 424 to allow the attendant to track the payment status. Once vendor sales system 412 has received a payment notice, such as an acknowledgement of the successful settlement of the transaction or a notice of the failure of the transaction, vendor sales system 412 transmits the notice (directly or indirectly through server 410) to the remote staff terminal 424.

Conventional payment methods in the full serve gas station context, such as processing a credit card, require the attendant to perform multiple steps including initiating the transaction with a fixed or mobile point of sale system, collecting the credit card from the consumer, moving to another location (such as an office or kiosk) to process the payment, returning to the consumer with the credit card and a receipt and then returning to the office or kiosk to file the consumer-signed receipt. The system and method of the invention allow for the consumer to conduct the transaction from within their car and simplifies the time-consuming multi-step process required by conventional methods. The attendant is not required to make multiple trips to and from the car, thus expediting the service. The need for the consumer to exit the car or even roll down the window to complete the transaction which can be inconvenient particularly during inclement weather is eliminated.

### Self Serve Gas Station

A further embodiment of the invention is used at a self serve gas station either to pay after pumping gas or to pre-approve a payment and arm a pump.

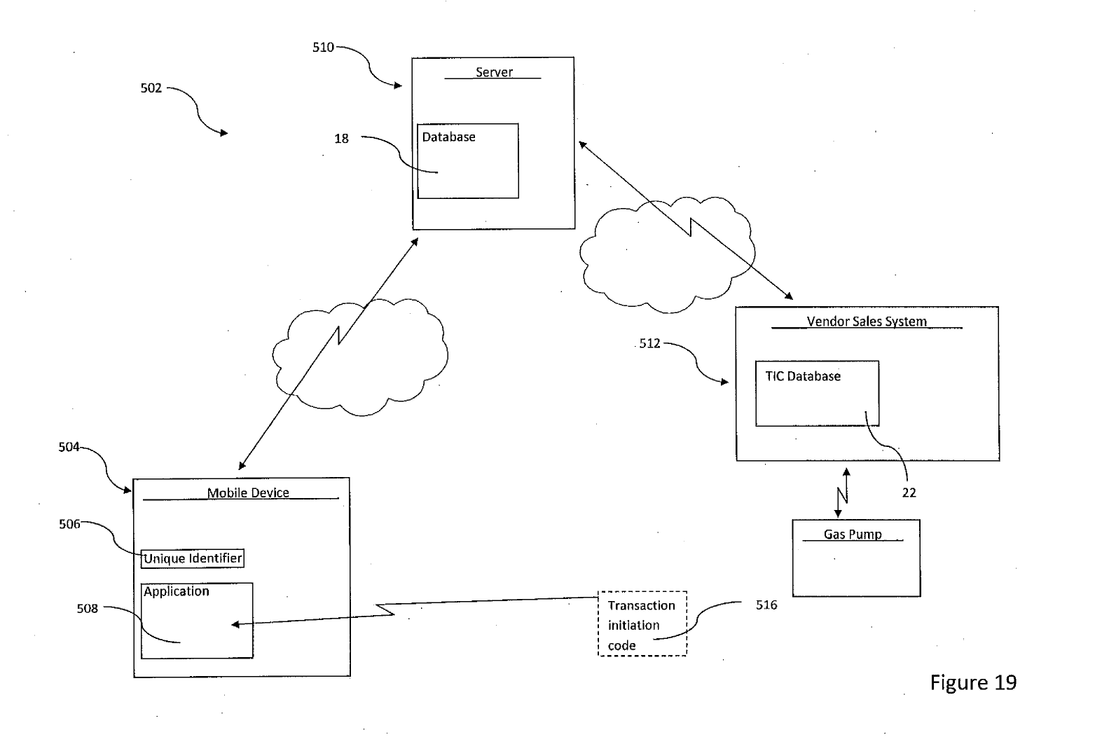

In this embodiment, the system 502, depicted in FIG. 19, includes a mobile device 504, with a unique identifier 506 and an application 508 associated with the gas station or gas station chain. It further includes a server 510, also associated with the gas station or gas station chain, containing a database 18 of the unique identifiers 506 of mobile devices 504 and corresponding associated payment facility information. Server 510 is capable of receiving signals from and transmitting signals to mobile device 504. System 502 further includes a vendor sales system 512 that can receive signals from and transmit signals to the server 510 and at least one gas pump.

In a first embodiment, the consumer pumps the gas into their vehicle without pre-approval of a payment facility. The consumer can then pay using their mobile device 504 as set out in the method disclosed in the general financial transaction example above. In such example, the consumer has the benefit of being able to pay for the gas without having to go inside the gas station.

In a second embodiment, as shown in FIGS. 2, 3 and 6A-B, the system is used to pre-authorize a payment facility, arm the pump and complete a financial transaction. With the vehicle in a suitable position at a gas pump, the consumer initiates application 508 on their mobile device 504 in step 1. In step 3, a TIC 516 is statically provided on the gas pump to identify which pump will be used. The consumer inputs TIC 516 into application 508 in any suitable manner in step 5. Using mobile device 504, application 508 transmits TIC 516 and the unique identifier 506 of the mobile device 504 to the server 510 in step 7. In step 15, server 510 retrieves the payment facility options corresponding to unique identifier 506 and allows the consumer to select a preferred payment facility according to the steps outlined in FIG. 3. At step 21, mobile device 504 transmits the selected payment facility to server 510. In step 11, server 510 transmits TIC 516 and the details of the payment facility selection to vendor sales system 512. Vendor sales system 512 checks to ensure that the pump is available in the TIC 516 check method 29 outlined in FIG. 4. Vendor sales system 512 includes a TIC database 22 that stores the TIC corresponding to each pump and tracks the pump activity. In step 31, vendor sales system 512 compares the input TIC 516 to the TIC database 22 to determine if the pump is free. If the pump is free, certain preliminary actions may be required of vendor sales system 512 at step 43 before the transaction can proceed. For example, vendor sales system 512 can seek a pre-authorization relating to the use of the selected payment facility for up to a pre-determined amount (typically $125) and, assuming such pre-authorization is received, transmitting a signal to the pump to arm it for operation. The method would resume further processing (step 13) shown in FIGS. 6A-B upon completion of the transfer of gas into the vehicle.

In another embodiment, a series of prompts may need to be answered before the pump is armed and the payment facility is processed. One example pertains to fleet trucks that use fleet cards as a payment facility. In such example, one or more prompting questions (prompts) are associated with the card. If a fleet card is selected as a payment facility, server 510 sends the detailed information relating thereto to vendor sales system 512. In response, vendor sales system 512 requests answers to the one or more prompts. The prompts may include questions pertaining to the odometer reading, a personal identification number (PIN), the particular vehicle in use or information pertaining to the job the driver is completing. Each prompt is preferably delivered from vendor sales system 512 to server 510 and in turn to mobile device 504 and responses delivered in reverse manner; accordingly vendor sales system 512, server 510, mobile device 504 and its application 508 are all configured appropriately to handle such communications. In one version, application 508 is specific to the vendor and the fleet operator so that the necessary prompts are most conveniently presented to the driver. The system and method of this embodiment allow the driver to remain in their vehicle for as long as possible which would be advantageous in inclement weather.

Vendor sales system 512 assesses the sufficiency of the driver's responses. If the responses are deemed adequate, the pre-authorization will be completed, the pump will be armed and the transaction will thereafter proceed according to the methods described above. If the responses are deemed inadequate (i.e. there may be some indication of fraud), the pre-authorization will not be completed and the pump will not be armed. A message can then be transmitted if desired from vendor sales system 512 to server 510 and mobile device 504 to notify the driver of the failed prompts.

### Entertainment Venue

Another embodiment of the system and method of the invention is used in circumstances when the vendor would like to deliver a product to a consumer who is located at a known position such as a specific seat or table. This embodiment is exemplified in venues that host entertainment events that use pre-assigned seating, such as many sporting venues and some theaters. To access such venues the consumer purchases a ticket which is associated with a particular location, such as a seat.

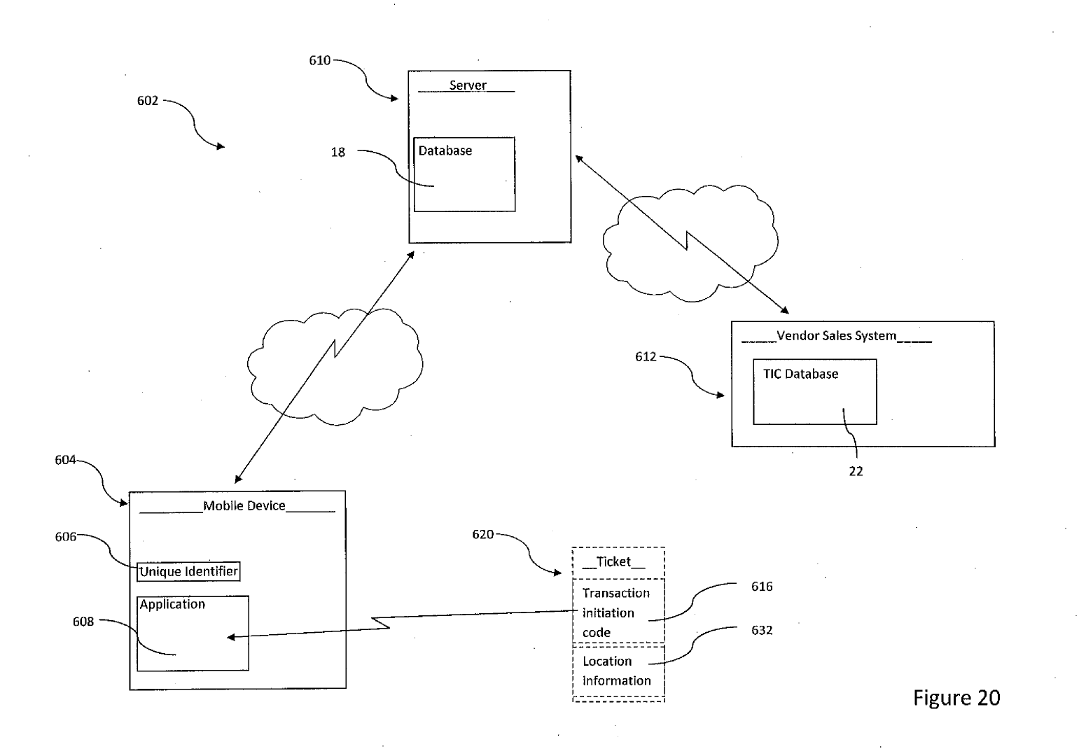

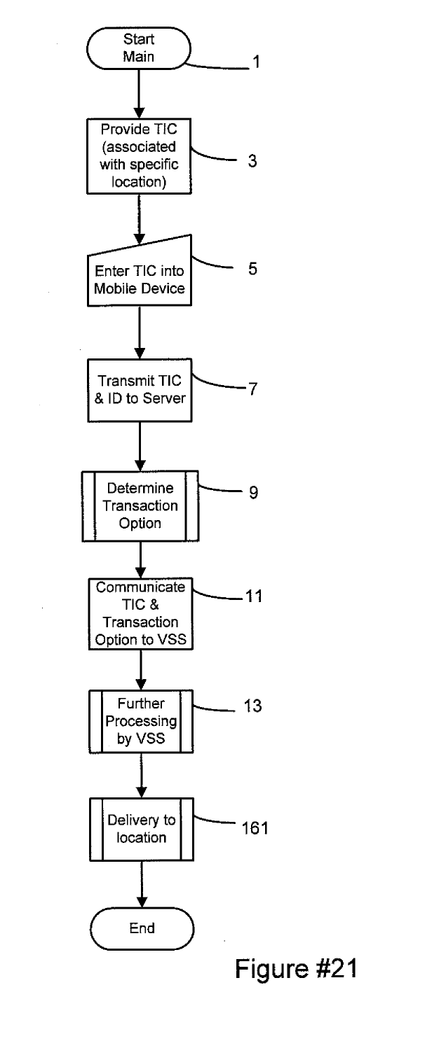

In this embodiment, the system 602, depicted in FIG. 20, includes a mobile device 604, with a unique identifier 606 and an application 608 associated with the venue or venue chain. It further includes a server 610, also associated with the venue or venue chain, containing a database 18 of the unique identifiers 606 of mobile devices 604 and corresponding payment facility information. Server 610 is capable of receiving signals from and transmitting signals to mobile device 604. System 602 further includes a vendor sales system 612 that can receive signals from and transmit signals to server 610.

The method of this embodiment is similar to the method used in the drive-through restaurant embodiment where both an order and financial transaction occur. A TIC 616 is associated with a seat number (or other location information) 632 at the time of ticket purchase and this information is stored in vendor's TIC database 22. In this embodiment, TIC 616 is printed by the vendor on, and is unique to, each ticket and is provide to the consumer (step 3 of FIG. 21) when the ticket is delivered to the consumer. As outlined in FIG. 21, the consumer enters TIC 616 (step 5) while at their seat into mobile device 604 at step 5 and TIC 616 and unique identifier 606 are transmitted to server 610 at step 7. In determining the transaction options, the method presented in FIG. 17 is used. This allows the consumer to choose both their order preference and their payment facility preference. These preferences and TIC 616 are transmitted from server 610 to vendor sales system 612 in step 11. The payment is processed in step 13. Vendor sales system 612 uses TIC 616 to retrieve the location of the consumer from TIC database 22. Knowing the location of the consumer, a staff member can deliver the order to the consumer in step 161. As in the drive-through restaurant embodiment, the consumer chooses from pre-set menu preferences or from a preset menu provided by the application.

Although the method described pertains to events with pre-assigned seating arrangements, it could also be implemented in at least some venues that do not have pre-assigned seating. For example, in a movie venue with multiple movie theaters, TIC 616 is used to denote in which theater the consumer located. The consumer then identify themselves (for example, by showing the TIC printed on the ticket) once the order has been brought to the theater. This would typically occur before the start of the movie so that other consumers are not disturbed. In another example, TIC 616 is used to order and pay for a food order. In one embodiment, delivery is to a central pick-up location. After a certain delay (or delivery of a prompt to the consumer when the order is ready for pick-up), the consumer leaves their seat, quickly and efficiently picks-up their order (identifying themselves by the TIC on their ticket) and returns to their seat with the least amount of delay.

The systems and methods described above allow consumers to be served without having to leave their seats and wait in lengthy lines to order, thus allowing the consumer to enjoy more of the entertainment event. Order errors caused by miscommunication between the consumer and the venue staff may also be reduced by placing the order electronically.

Advantageously, the present system and method provide payment convenience for consumers and vendors and/or improved transaction experiences (for example, simplified ordering, predetermined options and preferences, etc.).

The scope of the claims should not be limited by the preferred embodiments set forth in the examples, but should be given the broadest interpretation consistent with the description as a whole.

1. A method of ordering product or services and providing payment information used for completing a financial transaction associated with the order using mobile devices having unique identification codes in combination with a vendor sales system and a server having a database storing for each mobile device, the unique identification code, order options and payment information;
said method for each order comprising
providing a transaction initiation code;
entering the transaction initiation code into a mobile device;
transmitting the transaction initiation code and the unique identification code of the mobile device to the server;
receiving at the server the transaction initiation code and the unique identification code of the mobile device;
using the received unique identification code to access the database and obtain order options and payment information associated with the unique identification code;
transmitting the associated order options to the mobile device;
receiving at the mobile device the associated order options;
displaying the associated order options on the mobile device for user selection;
entering into the mobile device an order selection;
transmitting the order selection to the server;
receiving at the server the order selection; and
using the server to communicate the order selection, transaction initiation code and payment information to the vendor sales system for further processing and completing of the financial transaction.

2. A method as claimed in claim 1 wherein the payment information includes at least two payment facilities each capable of settling the financial transaction; and wherein said method includes transmitting identification of said payment facilities from said server to said mobile device and displaying the identification of said payment facilities to the user for selection; entering into the mobile device a payment facility selection and transmitting the payment facility selection to the server and using for the particular order said payment facility selection as said payment information transmitted to the vendor sales system.

3. A method as claimed in claim 1 or 2 wherein said step of entering the transaction initiation code includes initiating a transaction application installed on the mobile device and entering the transaction initiation code in the application as required.

4. (canceled)

5. (canceled)

6. A method as claimed in claim 1 or, 2 wherein said step of entering the transaction initiation code includes initiating a payment application specific to the vendor installed on the mobile device and entering the transaction initiation code in the payment application as required.

7. A method as claimed in any one of claim 1, 2 or 6 wherein said further processing includes the vendor sales system receiving an acknowledgement of confirmation of successful payment transmitting from the vendor sales system an acknowledgement of payment to the server;
receiving at the server the acknowledgement of payment,
transmitting the acknowledgement of payment to the mobile device; and
displaying at the mobile device said acknowledgement of payment.

8. A method of claim 7 wherein the transaction identification code further contains the unique identifier of a second mobile device and wherein said further processing includes the vendor sales system receiving an acknowledgement of confirmation of successful payment as part of said further processing, upon receiving the acknowledgement said vendor sales system transmitting acknowledgement of payment to the server, the server receiving the acknowledgement of payment and transmitting the acknowledgement of payment to the second mobile device, and the second mobile device displaying said acknowledgement of payment.

9. A method as claimed in any one of claim 1, 2, 3, 6, 7 or 8 wherein said server cooperates with said vendor sales system and provides an electronic receipt to an address associated with the mobile device.

10. A method as claimed in claim 7 wherein the server maintains a database of electronic receipts associated with the mobile devices that are accessible to the mobile device.

11. A method as claimed in claim 2 wherein the step of communicating the transaction initiation code and the payment facility selection to the vendor sales system for further processing of the financial transaction is a multi-step process that comprises the steps of
transmitting at the server the transaction identification code to the vendor sales system,
recalling transaction details stored in the vendor sales system using the transaction identification code,
transmitting the transaction details to the server,
receiving at the server the transaction details,
transmitting the transaction details to the mobile device;
displaying the transaction details on the mobile device,
receiving an authorization input into the mobile device,
transmitting authorization to the server, and
the server transmitting the authorization and payment facility to the vendor sales system for further processing of the financial transaction.

12. A method as claimed in claim 1 wherein the database includes one or more payment facilities with respect to each mobile device and said server and said mobile device cooperate to allow selection of a specific payment facility using the mobile device and used as payment information for settling the financial transaction.

13. (canceled)

14. (canceled)

15. (canceled)

16. (canceled)

17. (canceled)

18. A method as claimed in claim 1 wherein the step of obtaining order options comprises:
the server requesting order options from the vendor sales system;
the vendor sales system receiving the request for order options; and
transmitting the order options from the vendor sales system to the server.

19. A method as claimed in claim 1 further comprising the steps of:
using transaction initiation code and an associated predetermined location database stored in the vendor sales system to determine the delivery location for the order;
preparing the order; and
delivering the order to the delivery location.

20. A method as claimed in claim 19 wherein said ordering is associated with a theatre facility and said delivery location is a designated area within said theatre facility.

21. A method as claimed in claim 19 wherein said ordering is associated with a sporting facility and said delivery location is a designated area within said sporting facility.

22. A method as claimed in claim 19 wherein said ordering is associated with a sporting facility and said delivery location is a designated seat within said sporting facility.

23. A method as claimed in claim 1 wherein the method is applied in a-drive through restaurant having a drive through order screen and the transaction initiation code is provided on the drive through order screen.

24. A method as claimed in claim 23 wherein said drive through restaurant has a series of physical barriers to maintain the customers in the order in which the transaction codes were provided thereto.

25. A server for use in a system for ordering product or services and providing payment information used in completing a financial transaction associated with the order using mobile devices having unique identification codes in combination with a vendor sales system;
said server including a database, a processing arrangement, a transmitter and a receiver;
said database storing a host of entries with each entry including a unique identification code of a mobile device, order options and payment information;
said processing arrangement cooperating with said receiver to determine a first type of transmission including a transaction code and a unique ID and determining a second type of transmission including a transaction code, a unique ID and a selection order;
said processing arrangement upon determining a first type of transmission using said unique ID to access said database and determine order options and based thereon cooperating with said transmitter to transmit a signal to the mobile device identified by the unique id code the order options;
said processing arrangement upon determining a second type of transmission and based on information in said database sending a further transmission to a vendor server system that includes the transaction code, the selected option and payment information.
